(19) United States
(12) Patent Application Publication
(10) Pub. No.: US 2017/0093530 A1
(43) Pub. Date: Mar. 30, 2017

(54) TECHNIQUES FOR CHANNEL ESTIMATION AND PACKET DECODING USING AN ENHANCED LICENSE ASSISTED WI-FI HEADER

(71) Applicant: QUALCOMM Incorporated, San Diego, CA (US)

(72) Inventors: Shrinivas Kudekar, Bridgewater, NJ (US); Xinzhou Wu, Hillsborough, NJ (US); Junyi Li, Chester, NJ (US); Arik Gubeskys, Hod Hasharon (IL); Yehonatan Dallal, Kfar Saba (IL)

(21) Appl. No.: 14/864,574

(22) Filed: Sep. 24, 2015

(51) Int. Cl. H04L 1/06; H04W 72/12; H04B 7/08; H04L 5/00

(52) U.S. Cl. CPC H04L 1/0668; H04L 5/0053; H04W 72/1263; H04B 7/0854

(57) ABSTRACT

A wireless local area network (WLAN) may utilize an enhanced header for LTE-CW transmissions to increase utilization of the shared spectrum. In one example, a first device may generate a header that is identifiable to other devices using a shared spectrum, scramble, in the time domain, long training symbols according to a scrambling code that is specific to the first device, and transmit an enhanced header that includes the generated header and the scrambled long training symbols. The first device may also introduce a data region following the long training symbols to the enhanced header to create an enhanced packet. A second device may receive the enhanced packet and descramble the long training symbols based at least in part on the scrambling code that is specific to the first device to determine a channel estimate for the communication channel between the first device and the second device.

### BACKGROUND

Field of Disclosure

The following relates generally to wireless communication, and more specifically to techniques for channel estimation and packet decoding using an enhanced license-assisted Wi-Fi (Long Term Evolution (LTE)-CW) header in an LTE-CW network.

Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, single-carrier frequency-division multiple access (SC-FDMA) systems, and orthogonal frequency-division multiple access (OFDMA) systems.

By way of example, a wireless multiple-access communication system may operate according to a first radio access technology (RAT), such as LTE, and may include a number of base stations, each simultaneously supporting communications for multiple communication devices, otherwise known as user equipments (UEs). A base station may communicate with UEs on downlink channels (e.g., for transmissions from a base station to a UE) and uplink channels (e.g., for transmissions from a UE to a base station). A second wireless multiple-access communications system may operate according to a second RAT, such as Wi-Fi, and may include a number of base stations or access points (APs), each simultaneously supporting communication for multiple mobile devices or stations (STAs). APs may communicate with STAs on downstream and upstream links.

In a wireless local area network (WLAN), such as Wi-Fi, an AP may communicate with multiple STAs over a shared radio frequency spectrum. The STAs may use contention-based procedures that include communicating one or more control frames prior to establishing a communication link, such that confirmation of the communication link via exchange of control frames limits interference experienced by nearby communication devices. In an LTE network, a base station and a UE may communicate over a dedicated frequency spectrum, and the base station may coordinate uplink and downlink communications for connected UEs so that contention based procedures do not need to be used.

In some cases, a hybrid approach of WLAN and LTE may be utilized, where dedicated spectrum is used for network messaging (e.g., control information, radio resource control (RRC) signaling, etc.), while the shared spectrum is used for data transmission. This hybrid approach may be referred to as an LTE-CW network. In some cases, LTE-CW technology is utilized in an area that supports multiple APs. Simultaneous transmissions from the multiple APs may interfere with one another and may degrade communications between devices using the shared spectrum.

### SUMMARY

A WLAN network may utilize an enhanced header for LTE-CW transmissions to increase utilization of the shared spectrum. In one example, a first device (e.g., an LTE-CW device) may generate a header that is identifiable to other devices using a shared spectrum (e.g., Wi-Fi devices), scramble, in the time domain, long training symbols according to a scrambling code that is specific to the first device, and transmit an enhanced header that includes the generated header and the scrambled long training symbols. The first device may also introduce a data region following the long training symbols to the enhanced header to create an enhanced packet. A second device may receive the enhanced packet and descramble the long training symbols based at least in part on the scrambling code that is specific to the first device. After descrambling the long training symbols, the second device may determine a channel estimate for the communication channel between the first device and the second device.

A method of wireless communication is described. The method may include generating a header that is identifiable to a second RAT, scrambling, in the time domain, a plurality of long training symbols according to a scrambling code associated with the access point, the plurality of long training symbols associated with one or more neighboring access points, and transmitting an enhanced header, the enhanced header comprising the generated header and the scrambled plurality of long training symbols, the scrambled plurality of long training symbols transmitted after the generated header.

An apparatus for wireless communication is described. The apparatus may include means for generating a header that is identifiable to a second RAT, means for scrambling, in the time domain, a plurality of long training symbols according to a scrambling code associated with the access point, the plurality of long training symbols associated with one or more neighboring access points, and means for transmitting an enhanced header, the enhanced header comprising the generated header and the scrambled plurality of long training symbols, the scrambled plurality of long training symbols transmitted after the generated header.

A further apparatus for wireless communication is described. The apparatus may include a processor, memory in electronic communication with the processor, and instructions stored in the memory and operable, when executed by the processor, to cause the apparatus to generate a header that is identifiable to a second RAT, scramble, in the time domain, a plurality of long training symbols according to a scrambling code associated with the access point, the plurality of long training symbols associated with one or more neighboring access points, and transmit an enhanced header, the enhanced header comprising the generated header and the scrambled plurality of long training symbols, the scrambled plurality of long training symbols transmitted after the generated header.

A non-transitory computer-readable medium storing code for wireless communication is described. The code may include instructions executable to generate a header that is identifiable to a second RAT, scramble, in the time domain, a plurality of long training symbols according to a scrambling code associated with the access point, the plurality of long training symbols associated with one or more neighboring access points, and transmit an enhanced header, the enhanced header comprising the generated header and the scrambled plurality of long training symbols, the scrambled plurality of long training symbols transmitted after the generated header.

Some examples of the method, apparatuses, or non-transitory computer-readable medium described herein may further include processes, features, means, or instructions for identifying interference from a neighboring access point, and selecting a number of long training symbols based at least in part on the identified interference, wherein the plurality of long training symbols comprises the selected number of long training symbols.

In some examples of the method, apparatuses, or non-transitory computer-readable medium described herein, the scrambling further comprises applying an orthogonal code to the plurality of long training symbols, the orthogonal code associated with the access point. Additionally or alternatively, in some examples the orthogonal code is a Walsh code.

In some examples of the method, apparatuses, or non-transitory computer-readable medium described herein, the plurality of long training symbols comprises a first long training symbol and a second long training symbol, and wherein the Walsh code is (1,−1), and applying the first index ‘1’ to the first long training symbol and the second index ‘-1’ to the second long training symbol. Additionally or alternatively, some examples may include processes, features, means, or instructions for generating a data region with embedded narrowband tones for phase tracking, and transmitting the data region after the enhanced header, the enhanced header and data region together comprising an enhanced packet.

In some examples of the method, apparatuses, or non-transitory computer-readable medium described herein, the data region is scrambled according to a second scrambling code associated with the access point. Additionally or alternatively, some examples may include processes, features, means, or instructions for transmitting the enhanced packet over a channel that is shared by the first RAT and the second RAT.

Some examples of the method, apparatuses, or non-transitory computer-readable medium described herein may further include processes, features, means, or instructions for communicating control information over a subband of a licensed radio frequency spectrum band, the licensed radio frequency spectrum band comprising a narrow frequency channel. Additionally or alternatively, in some examples the control information comprises at least one of scheduling information for uplink transmissions, downlink transmissions, or a combination thereof, or an indication of the scrambling code associated with the access point.

Some examples of the method, apparatuses, or non-transitory computer-readable medium described herein may further include processes, features, means, or instructions for identifying a station is configured for license assisted Wi-Fi, and scrambling, in the time domain, the plurality of long training symbols based at least in part on the identification. Additionally or alternatively, some examples may include processes, features, means, or instructions for scrambling, in the frequency domain, the plurality of long training symbols based at least in part on a random sequence.

In some examples of the method, apparatuses, or non-transitory computer-readable medium described herein, the random sequence is a pseudo-random (PN) sequence.

A method of wireless communication is described. The method may include receiving, over a channel that is shared by the first RAT and a second RAT, an enhanced packet comprising an enhanced header, the enhanced header comprising a header that is identifiable by both the first RAT and the second RAT and a plurality of scrambled long training symbols received after the header, and descrambling, in the time domain, the plurality of long training symbols according to a descrambling code associated with an access point.

An apparatus for wireless communication is described. The apparatus may include means for receiving, over a channel that is shared by the first RAT and a second RAT, an enhanced packet comprising an enhanced header, the enhanced header comprising a header that is identifiable by both the first RAT and the second RAT and a plurality of scrambled long training symbols received after the header, and means for descrambling, in the time domain, the plurality of long training symbols according to a descrambling code associated with an access point.

A further apparatus for wireless communication is described. The apparatus may include a processor, memory in electronic communication with the processor, and instructions stored in the memory and operable, when executed by the processor, to cause the apparatus to receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header, and descramble, in the time domain, the plurality of long training symbols according to a descrambling code associated with an access point.

A non-transitory computer-readable medium storing code for wireless communication is described. The code may include instructions executable to receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header, and descramble, in the time domain, the plurality of long training symbols according to a descrambling code associated with an access point.

Some examples of the method, apparatuses, or non-transitory computer-readable medium described herein may further include processes, features, means, or instructions for identifying the descrambling code associated with the access point to descramble the plurality of scrambled long training symbols. Additionally or alternatively, some examples may include processes, features, means, or instructions for identifying long training symbols associated with one or more neighboring access points.

Some examples of the method, apparatuses, or non-transitory computer-readable medium described herein may further include processes, features, means, or instructions for determining a channel estimate for the channel based at least in part on the descrambled plurality of scrambled long training symbols. Additionally or alternatively, some examples may include processes, features, means, or instructions for identifying a data region within the enhanced packet, and decoding the data region based at least in part on the determined channel estimate.

Some examples of the method, apparatuses, or non-transitory computer-readable medium described herein may further include processes, features, means, or instructions for identifying a scrambled data region within the enhanced packet, and decoding the scrambled data region based at least in part on the determined channel estimate and a second descrambling code associated with the access point. Additionally or alternatively, some examples may include processes, features, means, or instructions for transmitting the channel estimate to the access point.

Some examples of the method, apparatuses, or non-transitory computer-readable medium described herein may further include processes, features, means, or instructions for estimating channel rotation based at least in part on the determined channel estimate and one or more narrow band tones embedded within a data region of the enhanced packet.

Some examples of the method, apparatuses, or non-transitory computer-readable medium described herein may further include processes, features, means, or instructions for performing interference rejection based at least in part on the determined channel estimate for the interfering channel.

Some examples of the methods, apparatuses, or non-transitory computer-readable media described herein may further include processes, features, means, or instructions for performing interference rejection based at least in part on the determined channel estimate for the interfering channel.

In some examples of the method, apparatuses, or non-transitory computer-readable medium described herein, performing interference rejection may include one or more of:

minimum mean square error (MMSE) interference cancellation, successive interference cancellation (SIC), or any combination thereof.

Some examples of the methods, apparatuses, or non-transitory computer-readable media described herein may further include processes, features, means, or instructions for channel estimation and packet decoding using an enhanced LTE-CW header. Further scope of the applicability of the described systems, methods, apparatuses, or computer-readable media will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system that supports channel estimation and packet decoding using an enhanced license assisted Wi-Fi (LTE-CW) header in accordance with various aspects of the present disclosure;

FIG. 2 illustrates an example of a wireless communications subsystem that supports channel estimation and packet decoding using an enhanced LTE-CW header in accordance with various aspects of the present disclosure;

FIG. 3 illustrates an example of an enhanced packet for channel estimation and packet decoding using an enhanced LTE-CW header in accordance with various aspects of the present disclosure;

FIG. 4 illustrates an example of a concurrent transmission of an enhanced packets 300 from two APs 105 for channel estimation and packet decoding using an enhanced LTE-CW header in accordance with various aspects of the present disclosure;

FIGS. 5A and 5B illustrate flow diagrams for channel estimation and packet decoding using an enhanced LTE-CW header in accordance with various aspects of the present disclosure;

FIG. 6 illustrates a process flow for channel estimation and packet decoding using an enhanced LTE-CW header in accordance with various aspects of the present disclosure;

FIGS. 7-9 show block diagrams of a wireless device that supports channel estimation and packet decoding using an enhanced LTE-CW header in accordance with various aspects of the present disclosure;

FIG. 10 illustrates a block diagram of a system including a station (STA) that supports channel estimation and packet decoding using an enhanced LTE-CW header in accordance with various aspects of the present disclosure;

FIGS. 11-13 show block diagrams of a wireless device that supports channel estimation and packet decoding using an enhanced LTE-CW header in accordance with various aspects of the present disclosure;

FIG. 14 illustrates a block diagram of a system including an access point (AP) that supports channel estimation and packet decoding using an enhanced LTE-CW header in accordance with various aspects of the present disclosure; and

FIGS. 15-19 illustrate methods for channel estimation and packet decoding using an enhanced LTE-CW header in accordance with various aspects of the present disclosure.

### DETAILED DESCRIPTION

According to the present disclosure, a wireless local area network (WLAN) may utilize an enhanced header for LTE-CW transmissions to increase utilization of the shared spectrum. Aspects of the disclosure are described in the context of a wireless communication system. For example, LTE-CW capable APs and LTE-CW capable STAs may operate using a shared spectrum for data transmissions and a dedicated spectrum (e.g., a narrow frequency band of licensed spectrum) for transmissions of control information. An LTE-CW AP may generate and transmit an enhanced LTE-CW packet that includes an enhanced LTE-CW header to a connected LTE-CW STA. The AP may scramble a portion of the enhanced LTE-CW header with an AP-specific scrambling code prior to transmitting the enhanced LTE-CW packet over a shared channel. In this way a receiving STA may isolate the enhanced LTE-CW packet transmission from other concurrent LTE-CW packet transmissions. The receiving STA may receive and descramble the portion of the enhanced LTE-CW packet based at least in part on the AP-specific scrambling code and may develop a channel estimate for the transmission path between the STA and the AP. The STA may then use the channel estimate to decode a data region included in the enhanced LTE-CW packet, for interference mitigation, and/or channel rotation estimation.

In one example, an AP generates an enhanced packet that includes a header that is identifiable to both devices that are and are not LTE-CW capable, long training symbols that are selected based at least in part on a number of neighboring/interfering APs in a certain area, and a data region that includes user data and embedded narrow band pilot symbols for channel phase tracking. The header and the long training symbols may compose an enhanced LTE-CW header that may be used by a receiving STA to isolate transmissions from one AP from another AP. The number of long training symbols to include subsequent to the header may be selected based at least in part on the number of interfering APs within a certain region. For instance, two long training symbols may be selected for an area with two interfering APs, four long training symbols for four interfering APs, eight long training symbols for eight interfering APs, etc. Each of the interfering APs may be assigned an AP-specific orthogonal scrambling code (e.g., a Walsh code) to apply to the long training symbols. The AP may then include a data region subsequent to the scrambled long training symbols and in some cases may scramble the data region to whiten the interference between concurrent transmissions for the data region. Each of the interfering APs may synchronously/concurrently transmit an enhanced packet over a shared spectrum.

A STA may receive and/or detect each of the transmitted enhanced packets. The headers included in the enhanced packets may coherently combine at the STA's receiver, and therefore, corrupt a channel estimate based at least in part on the header. Accordingly, the STA may apply a descrambling code, that is based at least in part on the AP-specific scrambling codes, to the detected transmissions. In this way, the STA may isolate the transmissions associated with each AP and may generate enhanced channel estimates that are specific to the transmission paths to/from each AP. The STA may apply the enhanced channel estimate associated with the serving AP to the received data region to more reliably decode the data region. In cases where the data region is also scrambled the STA may descramble the data and decode the data region based on the channel estimate and the scrambling code used for the data region. In some cases, the STA may also track channel phase rotation using the narrow band frequency tones embedded in the data region to further refine an enhanced channel estimate. The STA may further report the derived channel estimates to an AP, which may use the channel estimate reports for subsequent handoff/scheduling decisions. The STA may additionally use the channel estimate for interference rejection techniques such as MMSE, SIC, MRC, IRC, etc. These and other aspects of the disclosure are further illustrated by and described with reference to apparatus diagrams, system diagrams, and flowcharts.

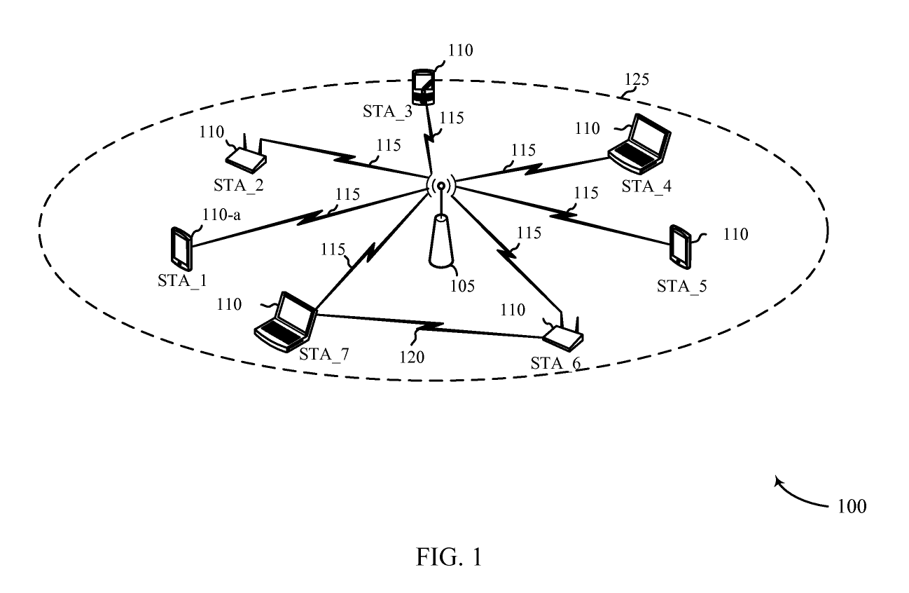

FIG. 1 illustrates an example of a network, such as a wireless local area network (WLAN) 100, for protecting communications in a WLAN in accordance with various aspects of the present disclosure. The WLAN 100 may include an AP 105 and STAs 110 labeled as STA_1 through STA_7. The STAs 110 may include mobile handsets, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, the WLAN 100 may have multiple APs 105. Each of the STAs 110, which may also be referred to as a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that STAs 110 within that area can typically communicate with the AP 105. The STAs 110 may be dispersed throughout the coverage area 125. Each STA 110 may be stationary or mobile.

A STA 110 may also be covered by more than one AP 105 and can therefore associate with multiple APs 105 at different times. A single AP 105 and an associated set of stations may be referred to as a basic service set (BSS). An extended service set (ESS) is a set of connected BSSs. A distribution system (DS) may be used to connect APs 105 in an extended service set. A coverage area 125 for an AP 105 may be divided into sectors making up only a portion of the coverage area. The WLAN 100 may include APs 105 of different types (e.g., metropolitan area, home network, etc.), with varying sizes of coverage areas and overlapping coverage areas for different technologies.

While the STAs 110 may communicate with each other through the AP 105 using communication links 115, each STA 110 may also communicate directly with other STAs 110 via a direct wireless communication link 120. Two or more STAs 110 may communicate via a direct wireless communication link 120 when both STAs 110 are in the AP coverage area 125, when one STA 110 is within the AP coverage area 125, or when neither of the STAs 110 are within the AP coverage area 125. Examples of direct wireless communication links 120 may include Wi-Fi Direct connections, connections established by using a Wi-Fi Tunneled Direct Link Setup (TDLS) link, and other peer-to-peer (P2P) group connections. The STAs 110 and APs 105 in these examples may communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11z, etc. In other implementations, other peer-to-peer connections or ad hoc networks may be implemented in WLAN 100. The WLAN network may perform communications over shared spectrum (e.g., unlicensed spectrum). Communications over shared spectrum may be conducted without pre-coordination, and devices transmitting over the shared spectrum may use collision prevention techniques to manage communications to/from multiple devices. Collision prevention techniques may include carrier sense multiple access (CSMA) with collision avoidance (CSMA/CA), request to send (RTS)/clear to send (CTS) protocols, enhanced distributed channel access (EDCA) protocols, and the like.

Other networks, such as a wireless wide area access network (WWAN) may utilize dedicated spectrum (e.g., licensed spectrum) for communications. Communication over dedicated spectrum may be coordinated by a central node (e.g., a base station), that schedules uplink and downlink resources for connected devices (e.g., a UE). Accordingly, a WWAN device may communicate without using contention-based protocols to determine whether resources in the dedicated spectrum are clear. In some cases, a WLAN network may utilize a thin frequency band of dedicated spectrum (e.g., for control and header transmissions), while using the shared spectrum for data transmission. In this way, a WLAN network, such as a license assisted Wi-Fi (LTE-CW) network, may utilize the shared spectrum while maintaining compatibility with an existing WLAN network, such as a Wi-Fi network. In some cases, neighboring APs 105 may communicate with one another via the dedicated spectrum to coordinate synchronous and/or parallel transmissions (e.g., for frequency reuse operation).

However, in some cases, parallel transmissions by neighboring APs 105 may interfere with one another and degrade the performance of the network. In one example, transmissions over the shared channel may include a common header that is used by a wireless device, such as a STA 110 for packet detection, automatic gain control (AGC), and/or channel estimation. During synchronous and parallel transmissions, these common headers may coherently combine at the receiver of a STA 110. For instance, a signal from a first AP 105 may propagate through a first channel, h^{eNE}^{₁}, while a signal from a second AP 105 may propagate through a second channel, h^{eNE}^{₂}. Thus, the channel estimate for the received signals at the receiver of the STA 110, h^{STA}, may equal h^{eNE}^{₁}+h^{eNE}^{₂}. Accordingly, a STA 110 may incorrectly estimate the channel conditions associated with the transmission path associated with a serving AP 105.

Therefore, a WLAN network may utilize enhanced transmission techniques for LTE-CW transmissions. In one example, an LTE-CW AP 105 may generate a header that is identifiable to a Wi-Fi device, scramble, in the time domain, the long training symbols according to a scrambling code that is specific to the LTE-CW AP 105, and transmit an enhanced header that includes the generated header and the scrambled long training symbols. The number of long training symbols may be chosen based at least in part on a number of interfering and/or neighboring APs 105 in a certain area. The LTE-CW AP 105 may introduce a data region following the long training symbols creating an enhanced packet and may transmit the enhanced packet over a shared spectrum. A STA 110 may receive the enhanced packet and descramble the long training symbols according to the scrambling code that is specific to the LTE-CW AP 105. After descrambling the long training symbols, the LTE-CW STA 110 may determine a channel estimate for the transmission path between the LTE-CW AP 105 and the LTE-CW STA 110. In some cases, the LTE-CW STA 110 may concurrently receive a second enhanced packet from a second LTE-CW AP 105 and may similarly determine a channel for estimate for the transmission path to the second LTE-CW AP 105. In this way, the WLAN network may enable an LTE-CW STA 110 to correctly estimate channel conditions for each of the transmission paths associated with the concurrent transmissions. Furthermore, the enhanced transmission techniques may enable the WLAN network to operate in a parallel mode while significantly reducing interference between transmitting nodes.

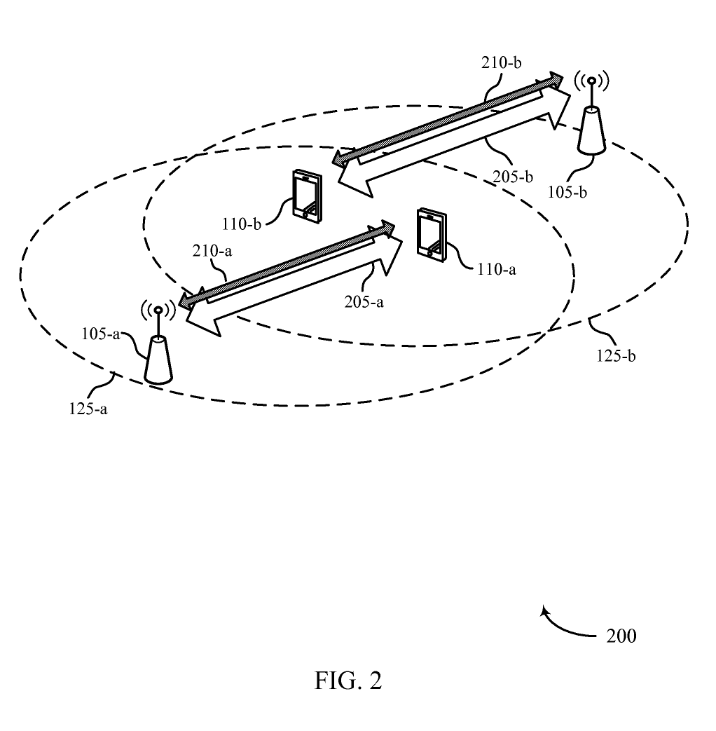

FIG. 2 illustrates an example of a wireless communications subsystem 200 that supports channel estimation and packet decoding using an enhanced LTE-CW header in accordance with various aspects of the present disclosure. Wireless communications subsystem 200 may include STA 110-a, STA 110-b, AP 105-a, and AP 105-b, which may be examples of a STA 110 or an AP 105 and may communicate with one another as described above with reference to FIG. 1. In one example, STA 110-a, STA 110-b, AP 105-a, and AP 105-b are WLAN devices that support LTE-CW operations and operate in the presence of other WLAN networks (e.g., Wi-Fi). AP 105-a and AP 105-b may communicate bi-directionally with STA 110-a and STA 110-b, respectively via data channels 205-a and 205-b and control channels 210-a and 210-b. In an LTE-CW network, transmissions over a data channel 205 may utilize the shared spectrum, while transmissions over a control channel 210 may utilize the dedicated spectrum.

In some cases, APs 105-a and 105-b may concurrently/synchronously transmit data to a single STA, which may include sending redundant information or separate strings of information to the STA 110. In other cases, APs 105-a and 105-b may concurrently/synchronously transmit data to separate STAs, such as STA 110-a and 110-b. In either scenario, transmissions to/from one AP may effect (e.g., interfere with) transmissions to/from the other AP. In this example, APs 105-a and 105-b may each be assigned unique scrambling codes (e.g., orthogonal codes and/or pseudo-random noise (PN) sequences) to distinguish one AP from another, and may signal the assigned scrambling codes to one or both of STAs 110-a and 110-b. APs 105-a and 105-b may construct an enhanced packet that includes: a header that is identifiable to both LTE-CW and Wi-Fi devices, long training symbols, and a data field, in that order. APs 105-a and 105-b may select a number of long training symbols to introduce after the header based at least in part on the number of interfering APs located within a certain area. For instance, the network may introduce eight long training symbols to an enhanced packet to resolve interference between eight nearby and/or interfering APs. In some cases, AP 105-a may detect an interfering transmission from AP 105-b and may increment the number of long training symbols that are introduced after the header. In this example, the network may direct AP 105-a and 105-b to introduce two long training symbols after the header. Each of AP 105-a and 105-b may then apply a unique scrambling code to the long training symbols. The scrambling code for each AP may be based at least in part on an AP's cell-id. In some cases, another scrambling code may be applied to the data field. Scrambling the data fields may whiten the interference between concurrent transmissions.

After scrambling the long training symbols, APs 105-a and 105-b may proceed to simultaneously transmit the enhanced data packets to STAs 110-a and 110-b, respectively. Both STA 110-a and STA 110-b may detect the transmissions at a receiver, and may use the header for packet detection. After detecting that a packet has been received, STA 110-a and STA 110-b may apply the scrambling code, associated with the respective serving AP (i.e., AP 105-a or AP 105-b, respectively), to the long training symbols in the detected packet. For instance, each of STA 110-a and 110-b may use the equation:

$$[ \begin{matrix}{Y}_{{LTF}_{1}} \\ {Y}_{{LTF}_{2}}\end{matrix} ] = [ \begin{matrix}{p}_{1 k}^{{eNB}_{1}} & {p}_{1 k}^{{eNB}_{2}} \\ {p}_{2 k}^{{eNB}_{1}} & {p}_{2 k}^{{eNB}_{2}}\end{matrix} ] [ \begin{matrix}{h}^{{eNB}_{1}} ( 0 , k ) \\ {h}^{{eNB}_{2}} ( 0 , k )\end{matrix} ] + noise , \qquad ( 1 )$$

to determine a channel estimate for each of AP 105-a and AP 105-b, where Y_{LTF}_{ₙ} is the nth received long training symbol, pₙ is the scrambling sequence associated with the nth AP, h^{eNE}^{ₙ} is the channel estimate for the nth AP, and where time, t, is from (0, k). In cases where the data region is also scrambled, STA 110-a and STA 110-b may use the channel estimate and the same or a different descrambling code to descramble and decode the data region. STA 110-a may also utilize the channel estimate associated with the interfering AP 105-b for interference rejection techniques (e.g., minimum mean square error (MMSE), maximum ratio combining (MRC), interference rejection combining (IRC), successive interference cancellation (SIC), etc.), to decode the data region. A more general matrix may be shown below:

$$[ \begin{matrix}{Y}_{{LTF}_{1}} \\ {Y}_{{LTF}_{2}} \\ ⋮ \\ {Y}_{{LTF}_{n}}\end{matrix} ] = \vert \begin{matrix}{p}_{1 k}^{{eNB}_{1}} & {p}_{1 k}^{{eNB}_{2}} & … & {p}_{1 k}^{{eNB}_{n}} \\ {p}_{2 k}^{{eNB}_{1}} & {p}_{2 k}^{{eNB}_{2}} & … & {p}_{2 k}^{{eNB}_{n}} \\ ⋮ & ⋮ & ⋱ & ⋮ \\ {p}_{nk}^{{eNB}_{1}} & {p}_{nk}^{{eNB}_{2}} & … & {p}_{nk}^{{eNB}_{n}}\end{matrix} \vert [ \begin{matrix}{h}^{{eNB}_{1}} ( 0 , k ) \\ {h}^{{eNB}_{2}} ( 0 , k ) \\ ⋮ \\ {h}^{{eNB}_{n}} ( 0 , k )\end{matrix} ] + noise . \qquad ( 2 )$$

In some cases, the data region includes embedded pilot tones which may be used to track the channel phase as will be described in more detail in the following discussion.

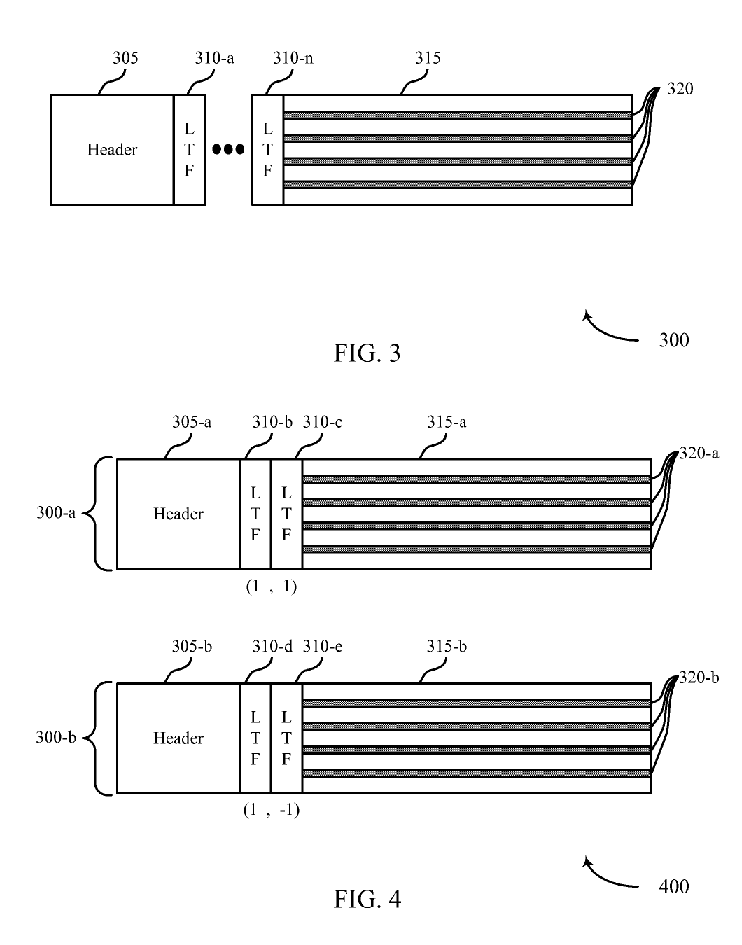

FIG. 3 illustrates an example of an enhanced packet 300 for channel estimation and packet decoding using an enhanced LTE-CW header in accordance with various aspects of the present disclosure. Enhanced packet 300 may illustrate aspects of a transmission between a STA 110 and an AP 105, as described above with reference to FIGS. 1-2. An enhanced packet 300 may include a header 305, long training field (LTF) symbols 310-a to 310-n, a data region 315, and pilot tones 320.

In one example, an AP may generate an enhanced packet for transmission over a shared spectrum. The AP may first generate header 305 to be identifiable to both Wi-Fi devices and LTE-CW devices. Header 305 may be used for packet detection by both types of devices and may direct a Wi-Fi device to refrain from accessing the channel for a period of time. The AP may additionally identify a number of interfering and/or neighboring APs in a network. The AP may determine the number of LTF symbols 310 to introduce based at least in part on identifying the number of neighboring APs. In some cases, a network controller may identify the number of APs in a given area and provide the APs with the number of LTF symbols 310 to introduce after header 305. In other cases, a user or network provider may identify the number of APs that will be located in a certain area and may configure the APs to operate using a certain number of LTF symbols 310. In yet other cases, an AP may increment/decrement the number of LTF symbols 310 based at least in part on detecting interfering transmissions from neighboring APs. For instance, by changing the level of a spreading factor (SPRF). Each AP may be assigned a unique scrambling code in one or both of the time-domain (e.g., Walsh codes) or the frequency domain (e.g., PN sequences). In some cases, the unique scrambling codes assigned to an AP may correspond to an AP's cell-id. The AP may apply the scrambling code to each set of LTF symbols 310-a to 310-n that is introduced after header 305.

In some cases, the scrambling codes may be Walsh sequences that are uniquely assigned to APs in a certain region. The number of Walsh sequences available for use may be determined by the density of the network, for instance based on the number of interfering nodes in the network. The number of available Walsh sequences may also be denoted by an SPRF. An AP may duplicate a long training symbol 310 based at least in part on identifying the SPRF and the Walsh sequence. For instance, for an SPRF=n and a Walsh sequence: [a, b, . . . , n], a long training symbol 310, X, may be duplicated n times to yield [X₁, X₂, . . . , Xₙ]. The duplicated long training symbols 310-a to 310-n may be multiplied element by element by the corresponding Walsh sequence [aX₁, bX₂, . . . nXₙ]. In one example, SPRF=4, the Walsh sequence is [1,1,−1,−1], and the resulting scrambled long training symbols 310 may be [X₁, X₂, −X₃, −X₄].

A STA receiving multiple transmissions from multiple APs using AP-specific scrambling codes, may resolve which channel characteristics are associated with which transmission paths between the STA and the APs to develop the respective channel estimates. In some cases, a STA may identify the scrambling code used by an AP after determining the AP's cell-id, while in other cases, the STA may receive a control message, such as an RRC message, indicating which scrambling codes are being used by which APs. In one example, a STA may receive an enhanced packet that is based at least in part on the above SPRF and Walsh sequence introduced above. The STA may multiply each received symbol by the corresponding code element and add the multiplied symbols to identify the original transmitted symbol. The long training symbols received at the STA's receiver may be given as:

[Y_{LTF}_{₁}(t1),Y_{LTF}_{₂}(t2),Y_{LTF}_{₃}(t3),Y_{LTF}_{₄}(t4)]=h^{eNE}^{₁}*[aX₁,bX₂,cX₃,dX₄]+h^{eNB}^{₂}*[eY₁,fY₂,gY₃,hY₄]+[N(t1),N(t2),N(t3),N(t4)], (3)

where Xₙ is associated with the long training symbols 310 transmitted from a first AP; Yₙ may be associated with long training symbols 310 transmitted from a second AP; h^{eNB}^{₁} may be associated with the channel to the first AP; h^{eNB}^{₂} may be associated with the channel to the second AP; N(t) may be associated with noise at time t; and Y_{LTF}_{ₙ}(t) is the received long training symbols at time t. Additionally, [a, b, c, d] may be associated with the Walsh sequence used at the first AP and [e, f, g, h] may be the Walsh sequence associated with the second AP. In some cases, a different long training symbol 310 may be received at each time period: t1, t2, etc.

Utilizing the orthogonality between the sequences, the STA may isolate h^{eNB}^{₁} based at least in part on determining:

Y=h^{eNB}^{₁}*[aY_{LTF}_{₁}(t1),bY_{LTF}_{₂}(t2),cY_{LTF}_{₃}(t3),dY_{LTF}_{₄}(t4)]+[N(t1),N(t2),N(t3),N(t4)] (4)

For instance, the received LTF symbols Y_{LTF}_{₁} may be summed and compared with Y, which may be a known value, to determine h^{eNB}^{₁}. In some cases, such as in relatively flat channels, the spreading can be implemented in frequency rather than in time to further reduce overhead. Similarly, the long training symbols 310 may be made shorter to fit additional long training symbols within a time period t. In some cases, the STA may similarly isolate h^{eNB}^{₂} to determine a channel estimate for the path between the second/interfering AP and may use the channel estimate for interference cancellation and rejection in the subsequent decoding of the data region.

Subsequent to the LTF symbols 310, the AP may introduce data region 315. Data region 315 may include data for a STA in addition to embedded pilot tones 320, which may be used for channel phase tracking. A STA may use the received pilot tones 320, Y(t, f), and the channel estimates from the LTF symbols 310 for each AP, h^{eNB}^{ₙ}, to track the channels phase. The equation for a received data pilot in a channel with two APs is given below:

Y(t,f)=h^{eNB}^{₁}(0,f)e^{-j2πf(phase}^{_}^{slope}^{₁}^{(t))}e^{-j2π(phase}^{_}^{offset}₁(t)+h^{eNB}^{₂}(0,f)e^{-j2π(phase}^{_}^{slope}^{₂}^{(t))}e^{-j2π(phase}^{_}^{offset}^{₂}^{(t))}+noise. (5)

The STA may estimate the phase_slopeₙ(t) using predicted slope tracking. Accordingly, the STA may estimate the phase_offsetₙ(t) using each of the embedded pilots to track channel rotation due to the phase offsets.

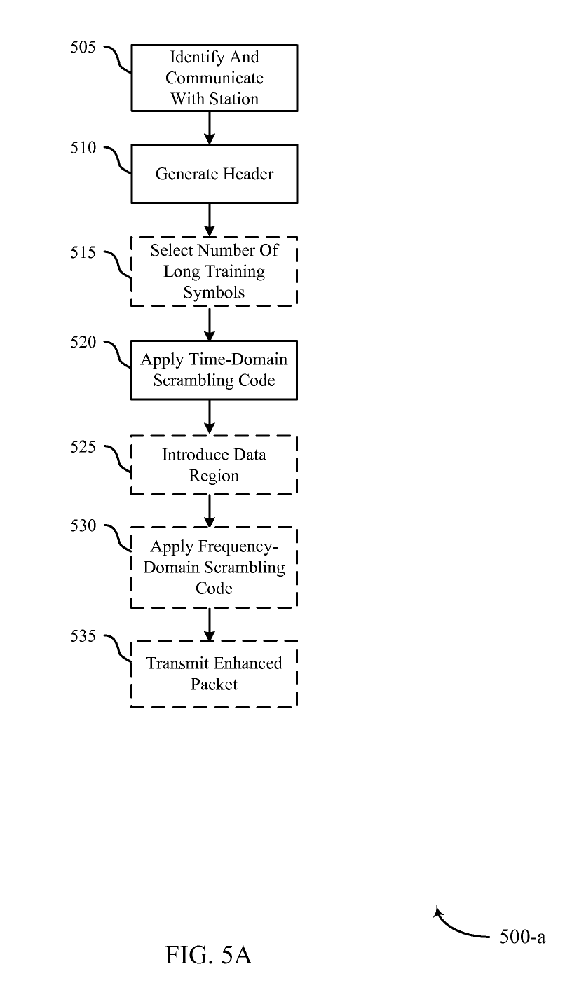

FIG. 4 illustrates an example of a concurrent transmission 400 of enhanced packets 300 from two APs 105 for channel estimation and packet decoding using an enhanced LTE-CW header in accordance with various aspects of the present disclosure. Concurrent transmissions 400 may illustrate aspects of transmissions between STAs 110 and APs 105, as described above with reference to FIGS. 1-3. Concurrent transmissions 400 may include enhanced packet 300-a and enhanced packet 300-b, which may include headers 305-a and 305-b, data regions 315-a and 315-b, embedded pilot tones 320-a and 320-b, and each may include two LTF symbols 310-b and 310-c and 310-d and 310-e, respectively.

In this example, two nearby APs conduct simultaneous transmissions over a shared channel. Each of the APs has been assigned a unique scrambling code, which in this example corresponds to unique Walsh codes, that will be applied to common LTF symbols 310-b and 310-e (i.e., LTF symbols 310-b and 310-c are generated to be the same as LTF symbols 310-d and 310-e). The first AP generates enhanced packet 300-a, and the second AP generates enhanced packet 300-b in accordance with aspects of generating an enhanced packet 300 as discussed in FIG. 3. In this example, the first AP is assigned the Walsh code [1, 1], while the second AP is assigned the Walsh code [1,−1]. In this example, the first AP applies the Walsh code [1, 1] to LTF symbols 310-b and 310-c. In some examples, applying this code yields the same output as the input. The second AP applies the Walsh code [1,−1] to LTF symbols 310-d to 310-e, which may invert (e.g., rotate the phase 180°) the second LTF symbol 310-e. After applying the Walsh codes the LTF symbols 310-b and 310-c may be orthogonal to the LTF symbols 310-d and 310-e. As generally discussed above, this may enable a receiving STA to decode and separate the channel characteristics associated with the first and second APs. Accordingly, the STA may determine channel estimates for the transmission paths for both APs. In some cases, the STA may report the channel estimates to the APs to refine subsequent transmissions and/or for subsequent scheduling and handoff decisions. The STA may additionally use the channel estimates to decode one of data region 315-a or data region 315-b based at least in part on the AP that is serving the STA. In cases where both transmission are intended for the STA, the STA may use the separate channel estimates to separately decode both data regions 315-a and 315-b.

For cases with three to four APs, four LTF symbols 310 may be added and the Walsh codes: [1, 1, 1, 1]; [1, 1, −1, 1]; [1, −1, 1, −1]; and [1, −1, −1, 1] may be applied to the LTF symbols 310 according to each AP, respectively. Similarly, further LTF symbols 310 may be added to support additional Walsh codes and additional APs within a certain region.

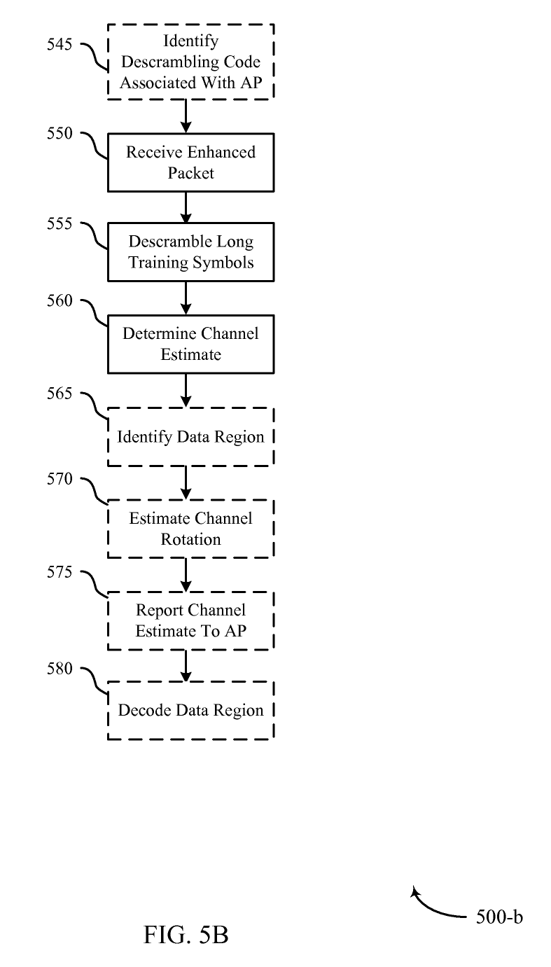

FIG. 5A illustrates a flow diagram 500-a for channel estimation and packet decoding using an enhanced LTE-CW header in accordance with various aspects of the present disclosure. Flow diagram 500-a may be performed by an AP 105 as described above with reference to FIGS. 1-4. In one example, an AP may support LTE-CW and serve STAs that do not support LTE-CW, which may be referred to as Wi-Fi STAs in the following discussion for sake of clarity, in addition to STAs that do support LTE-CW, which may be referred to as LTE-CW STAs in the following discussion for sake of clarity. In one example, the AP generates an enhanced packet for transmission to a STA in accordance with the following features.

At 505, the AP may identify a STA that is configured for LTE-CW and communicate control information to a STA over dedicated spectrum (e.g., licensed spectrum) using a narrow frequency channel. The control information may include scheduling information (e.g., uplink/downlink grants) for uplink or downlink transmissions and/or an indication of a scrambling code that is specific to the AP. The control information may also include scrambling codes that are specific to other APs in a certain area. In some cases, the STA may signal to the AP an indication that the STA supports LTE-CW operation via the dedicated spectrum.

At 510, the AP may generate a header (e.g., a header 305) that is identifiable to both Wi-Fi STAs and LTE-CW STAs. For instance, AP may generate a header that includes short training fields, long training fields, and a signal fields that are identifiable to both Wi-Fi and LTE-CW STAs. In some examples, both sets of STAs may use the short training field for packet detection, the Wi-Fi STAs may use a long training field for channel estimation, and the signal field may communicate data rate and length information that indicates to the Wi-Fi STAs a transmission deferral period for subsequent transmissions.

At 515, the AP may identify a number of long training symbols (e.g., LTF symbols 310) to introduce after the generated header based at least in part on an identified number of neighboring APs that may interfere with transmissions from the AP. For instance, the AP may be configured to use two long training symbols if there are two interfering APs (included the first AP); four long training symbols if there are three to four interfering APs (included the first AP), eight long training symbols if there are five to eight interfering APs (included the first AP), etc. The AP may insert the long training symbols after the generated header to obtain an enhanced header. In some cases, the long training symbols are inserted into the enhanced header via PHY layer processing. In other cases, the AP may be initialized at level SPRF_1 (i.e., SPRF=1), which may be associated with one or no long training symbols being introduced after the generated header. After identifying interfering transmissions from a neighboring AP, the AP may increment the SPRF level to SPRF_2 and may introduce two long training symbols after the generated header according to a certain Walsh sequence. The neighboring AP may similarly detect interfering transmissions from the AP and increment the SPRF level at the neighboring AP to SPRF_2. In this way a decentralized network may sense when to implement SPRFs of different sizes without pre-coordination. The APs may continue to increment/decrement the SPRF level based at least in part on identifying interfering transmissions from other APs.

At 520, the AP may scramble, in the time domain, the long training symbols according to an AP specific scrambling code. Scrambling the long training symbols may include applying an orthogonal code, that is specific to the AP, to the long training symbols. In some cases, the orthogonal code may be a Walsh code. For instance, the AP may introduce two long training symbols after the generated header and a Walsh code [−1, 1] that is specific to the AP may be applied to the long training symbols. For example, by applying ‘-1’ to the first long training symbol and applying ‘1’ to the second long training symbol. A second AP may also apply an orthogonal Walsh code, such as [1, 1] to two long training symbols after a generated header. In other examples, extended Walsh codes may be utilized based at least in part on the number of interfering APs in a region. In some cases, the scrambling may be based at least in part on identifying that the receiving STA is configured for license assisted Wi-Fi.

At 525, the AP may introduce a data region (e.g., a data region 315) after the enhanced header to obtain an enhanced packet. The AP may also embed narrow band tones (e.g., pilot tones 320) within the data region for phase tracking. In some cases, the AP includes four narrow band tones within the data region.

At 530, the AP may scramble the enhanced packet. In some cases, the AP may scramble, in the frequency domain, the plurality of long training symbols based at least in part on a random sequence. In some cases, the random sequence may be a PN sequence. In some cases, the AP may also scramble the data region using a scrambling code, that may be different than the AP-specific orthogonal code use for the long training symbols, that is associated with the AP. For instance, the AP may scramble the data region with the PN sequence used to scramble the enhanced packet. By scrambling the data region, APs may whiten the interference that may occur between concurrent transmissions.

At 535, the AP may transmit the enhanced packet over a channel that is shared by devices using LTE-CW and Wi-Fi. The foregoing provides one example of a process for channel estimation and packet decoding using an enhanced LTE-CW header. In other examples, one or more of the above features may be performed in an alternative order, concurrently with other features, or omitted from the process.

FIG. 5B illustrates a flow diagram 500-b for channel estimation and packet decoding using an enhanced LTE-CW header in accordance with various aspects of the present disclosure. Flow diagram 500-b may be performed by a STA 110 as described above with reference to FIGS. 1-4. In some examples, a STA supports LTE-CW and operates in a network that supports LTE-CW devices (e.g., LTE-CW STAs and LTE-CW APs), in addition to Wi-Fi devices (e.g., Wi-Fi STAs and Wi-Fi APs). In one example, the STA receives an enhanced packet from an AP and descrambles and decodes the enhanced packet in accordance with the following features.

At 545, the STA may identify the descrambling code that is specific to the AP to descramble the plurality of scrambled long training symbols. For instance, the STA may identify the descrambling code associated with the AP is a Walsh code that includes the indices [1, −1]. In some cases, the STA may identify multiple descrambling codes that are specific to multiple APs. In some cases, the STA may receive the descrambling code via a control channel that utilizes a narrow band of dedicated spectrum. the STA may also receive control information, such as uplink/downlink grants, via the control channel.

At 550, the STA may receive, over a channel that is shared by LTE-CW and Wi-Fi devices, an enhanced packet that includes a header that is identifiable by both types of devices and scrambled long training symbols after the header. In some cases, the enhanced packet also includes a scrambled data region, while in other cases, the enhanced packet may include a data region that has not been scrambled. In some cases, the data region may include embedded narrow band tones.

At 555, the STA may descramble, in the time domain, the long training symbols according to a descrambling code specific to the AP. In some cases, the STA may identify the long training symbols are associated with multiple APs (e.g., may determine the long training symbols are being used to resolve interference between multiple APs).

At 560, the STA may determine a channel estimate for the shared channel based at least in part on the descrambled plurality of scrambled long training symbols. In some cases, STA may determine a channel estimate associated with multiple APs. For instance, STA may determine the channel estimate associated with the transmission path between the STA and a serving AP, in addition to determining the channel estimate associated with the transmission path between the STA and an interfering AP based at least in part on the descrambled long training symbols. The STA may use the channel estimates associated with the interfering APs for interference mitigation operation, such as interference cancellation and rejection. For instance, the STA may use the interfering channel estimate for MMSE, SIC, MRC, IRC, etc. Any of the foregoing interference techniques may be used by the STA for subsequent decoding of the data region.

At 565, the STA may identify the data region. In some cases, the STA may identify that the data region is a scrambled data region. In some cases, the data region is scrambled with a different scrambling code than the scrambling code used for the long training symbols. In some examples, the data region may include control and/or user data for the STA.

At 570, the STA may estimate channel rotation based at least in part on the narrow band tones embedded within the data region and the channel estimate. Estimating the channel rotation may further include estimating the phase slope associated with the channel that is shared by the first RAT and a second RAT. In some cases, the STA may supplement the channel estimate with the estimated channel rotation.

At 575, the STA may report the channel estimate to the AP, where the channel estimate report may include the channel estimate and the estimated channel rotations. In some cases, the STA may report a channel estimate report associated with multiple APs. In these cases, an AP may use the received channel estimate reports for subsequent scheduling and handoff decisions.

At 580, the STA may decode the data region based at least in part on the channel estimate, the channel rotation estimate and/or, if the data region is scrambled, based at least in part on a second descrambling code associated with the AP. The foregoing provides one example of a process for channel estimation and packet decoding using an enhanced LTE-CW header. In other examples, one or more of the above features may be performed in an alternative order, concurrently with other features, or omitted from the process. In some cases, aspects of the flow diagram 500-b may be combined with the flow diagram 500-a as described with reference to FIG. 5A.

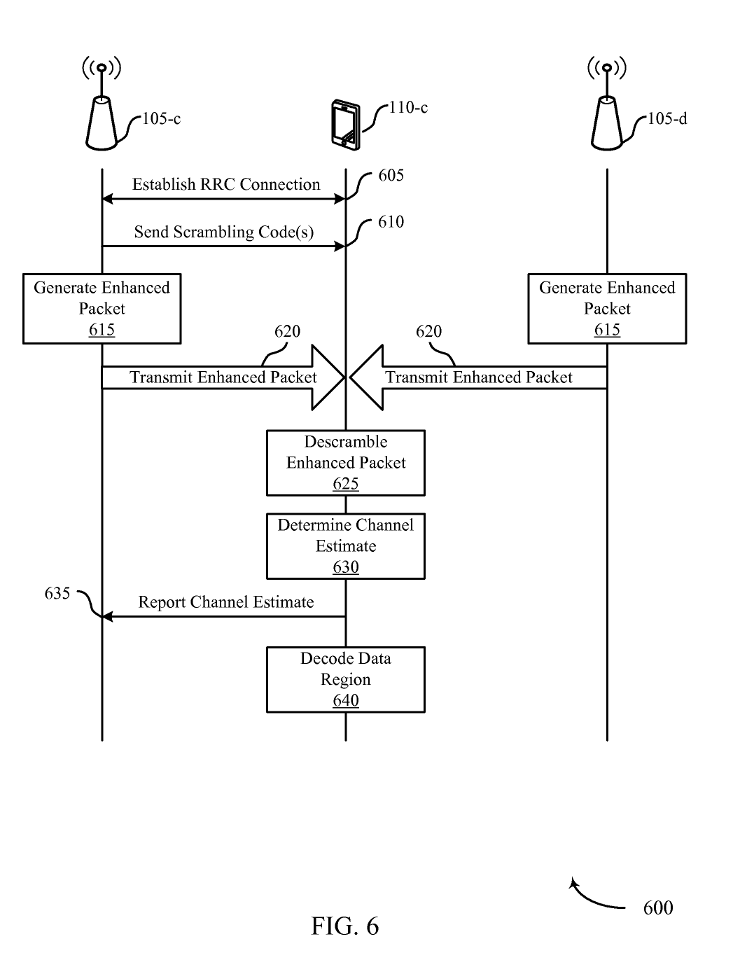

FIG. 6 illustrates a process flow 600 for channel estimation and packet decoding using an enhanced LTE-CW header in accordance with various aspects of the present disclosure. Process flow 600 may be performed by AP 105-c, AP 105-d, and STA 110-c, which may be examples of an AP 105 and/or a STA 110 as described above with reference to FIGS. 1-5B. In one example, STA 110-c, AP 105-c, and AP 105-d support LTE-CW and perform aspects of flow diagrams 500-a and 500-b as described with reference to FIGS. 5A and 5B.

For instance, at 605, AP 105-c and STA 110-c may establish a connection, which may include an association procedure for STA 110-c. In some cases, STA 110-c may send an indication of an LTE-CW capability to AP 105-c after establishing a connection. At 610, after identifying STA 110-c is LTE-CW capable, AP 105-c may send STA 110-c an indication of the scrambling codes that are unique to AP 105-c and/or AP 105-d. At 615, AP 105-c and AP 105-d may generate enhanced packets, and at 620, AP 105-c may transmit an enhanced packet to STA 110-c, while AP 105-d may transmit an interfering enhanced packet that is also detected by STA 110-c. At 625, STA 110-c may receive and descramble the enhanced packet, and at 630, STA 110-c may determine a channel estimate. At 635, STA 110-c may report the channel estimate to AP 105-c as described with respect to FIG. 5B, and at 640, STA 110-c may decode the data region as described with respect to FIG. 5B.

The foregoing provides one example of a process flow for channel estimation and packet decoding using an enhanced LTE-CW header. In other examples, one or more of the above features may be performed in an alternative order, concurrently with other features, or omitted from the process.

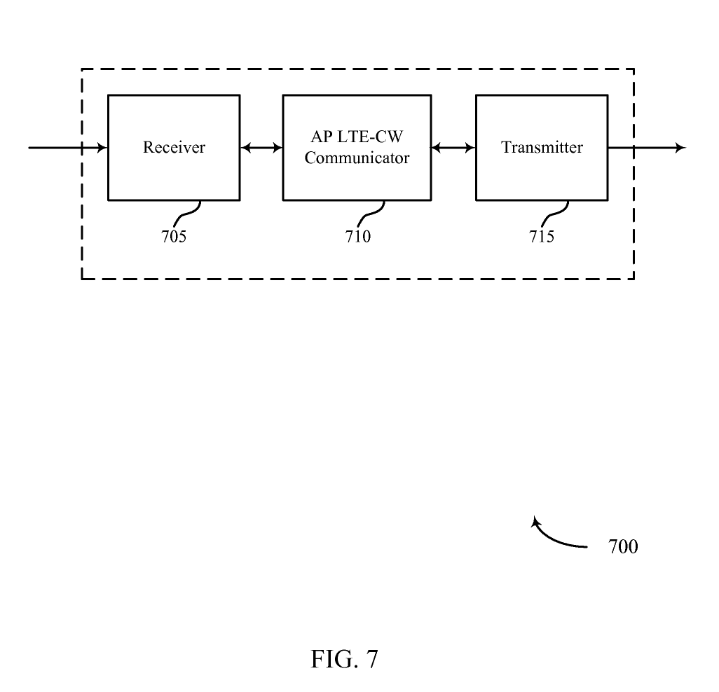

FIG. 7 shows a block diagram of a wireless device 700 configured for channel estimation and packet decoding using an enhanced LTE-CW header in accordance with various aspects of the present disclosure. Wireless device 700 may be an example of aspects of an AP 105 described with reference to FIGS. 1-6. Wireless device 700 may include a receiver 705, an AP LTE-CW communicator 710, or a transmitter 715. Wireless device 700 may also include a processor. Each of these components may be in communication with each other.

The receiver 705 may receive information such as packets, user data, or control information associated with various information channels (e.g., control channels, data channels, and information related to channel estimation and packet decoding using an enhanced LTE-CW header, etc.). Information may be passed on to the AP LTE-CW communicator 710, and to other components of wireless device 700.

The AP LTE-CW communicator 710 may generate a header that is identifiable to a second RAT, scramble, in the time domain, a plurality of long training symbols according to a scrambling code associated with the AP, the plurality of long training symbols associated with one or more neighboring APs, and transmit an enhanced header, the enhanced header comprising the generated header and the scrambled plurality of long training symbols, the scrambled plurality of long training symbols transmitted after the generated header.

The transmitter 715 may transmit signals received from other components of wireless device 700. In some examples, the transmitter 715 may be collocated with the receiver 705 in a transceiver module. The transmitter 715 may include a single antenna, or it may include a plurality of antennas. In some examples, the transmitter 715 may transmit, over a channel that is shared by the first RAT and the second RAT, the enhanced header, the enhanced header comprising the generated header and the scrambled plurality of long training symbols, the scrambled plurality of long training symbols transmitted after the generated header.

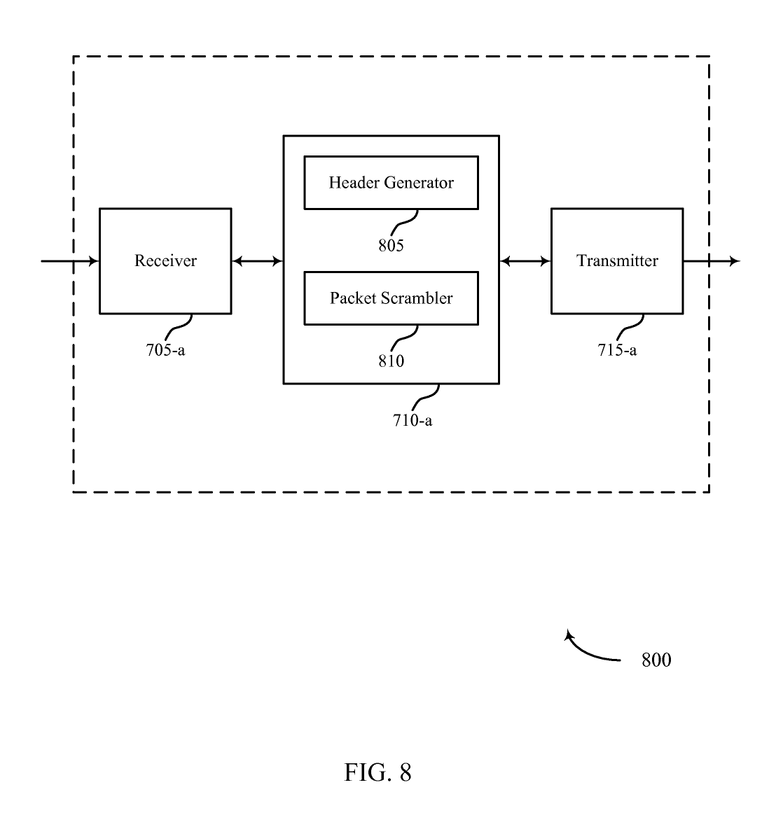

FIG. 8 shows a block diagram of a wireless device 800 for channel estimation and packet decoding using an enhanced LTE-CW header in accordance with various aspects of the present disclosure. Wireless device 800 may be an example of aspects of a wireless device 700 or an AP 105 described with reference to FIGS. 1-6. Wireless device 800 may include a receiver 705-a, an AP LTE-CW communicator 710-a, or a transmitter 715-a. Wireless device 800 may also include a processor. Each of these components may be in communication with each other. The AP LTE-CW communicator 710-a may also include a header generator 805 and a packet scrambler 810.

The receiver 705-a may receive information which may be passed on to AP LTE-CW communicator 710-a, and to other components of wireless device 800. The AP LTE-CW communicator 710-a may perform the operations described with reference to FIG. 7. The transmitter 715-a may transmit signals received from other components of wireless device 800. The header generator 805 may generate a header that is identifiable to a second RAT as described with reference to FIGS. 2-6.

The packet scrambler 810 may scramble, in the time domain, a plurality of long training symbols according to a scrambling code associated with the AP, the plurality of long training symbols associated with one or more neighboring APs as described with reference to FIGS. 2-6. In some examples, the scrambling further comprises applying an orthogonal code to the plurality of long training symbols, the orthogonal code associated with the AP. In some examples, the orthogonal code may be a Walsh code. In some examples, the packet scrambler 810 may select a number of long training symbols based at least in part on identified interference, wherein the plurality of long training symbols comprises the selected number of long training symbols. In some examples, the plurality of long training symbols comprises a first long training symbol and a second long training symbol, and wherein the Walsh code may be [1,−1]. The packet scrambler 810 may also apply the first index ‘1’ to the first long training symbol and the second index ‘-1’ to the second long training symbol. In some examples, the data region may be scrambled according to a second scrambling code associated with the AP. The packet scrambler 810 may also scramble, in the time domain, the plurality of long training symbols based at least in part on the identification. The packet scrambler 810 may also scramble, in the frequency domain, the plurality of long training symbols based at least in part on a random sequence. In some examples, the random sequence may be a PN sequence.

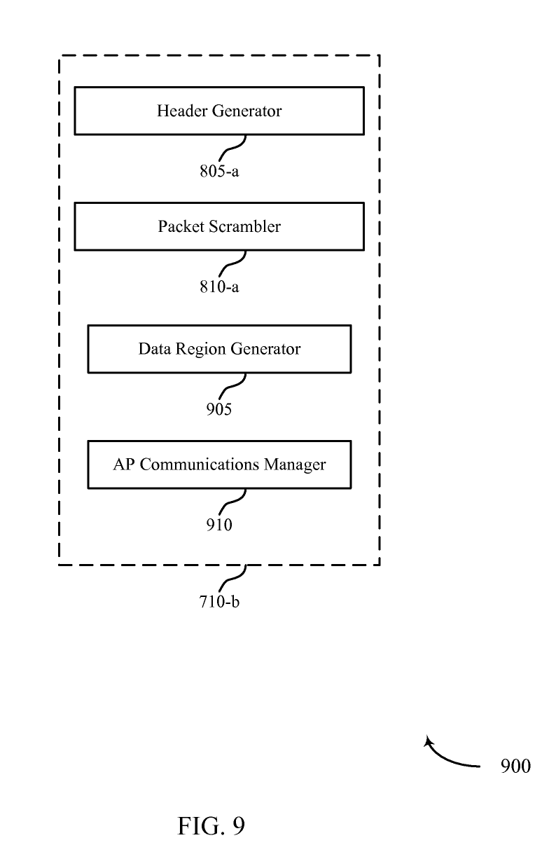

FIG. 9 shows a block diagram 900 of an AP LTE-CW communicator 710-b which may be a component of a wireless device 700 or a wireless device 800 for channel estimation and packet decoding using an enhanced LTE-CW header in accordance with various aspects of the present disclosure. The AP LTE-CW communicator 710-b may be an example of aspects of an AP LTE-CW communicator 710 described with reference to FIGS. 7-8. The AP LTE-CW communicator 710-b may include a header generator 805-a, a packet scrambler 810-a, and a packet descrambler 815-a. Each of these modules may perform the functions described with reference to FIG. 8. The AP LTE-CW communicator 710-b may also include a data region generator 905 and a AP communications manager 910.

The data region generator 905 may generate a data region with embedded narrowband tones for phase tracking as described with reference to FIGS. 2-6. The AP communications manager 910 may communicate control information over a subband of a licensed radio frequency spectrum band, the licensed radio frequency spectrum band comprising a narrow frequency channel as described with reference to FIGS. 2-6. In some examples, the control information comprises at least one of scheduling information for uplink transmissions and/or downlink transmissions or an indication of the scrambling code associated with the AP. The AP communications manager 910 may also identify a station is configured for license assisted Wi-Fi. The AP communications manager 910 may also identify the descrambling code associated with the AP to descramble the plurality of scrambled long training symbols. In some cases, the AP communications manager 910 may identify interference from a neighboring access point.

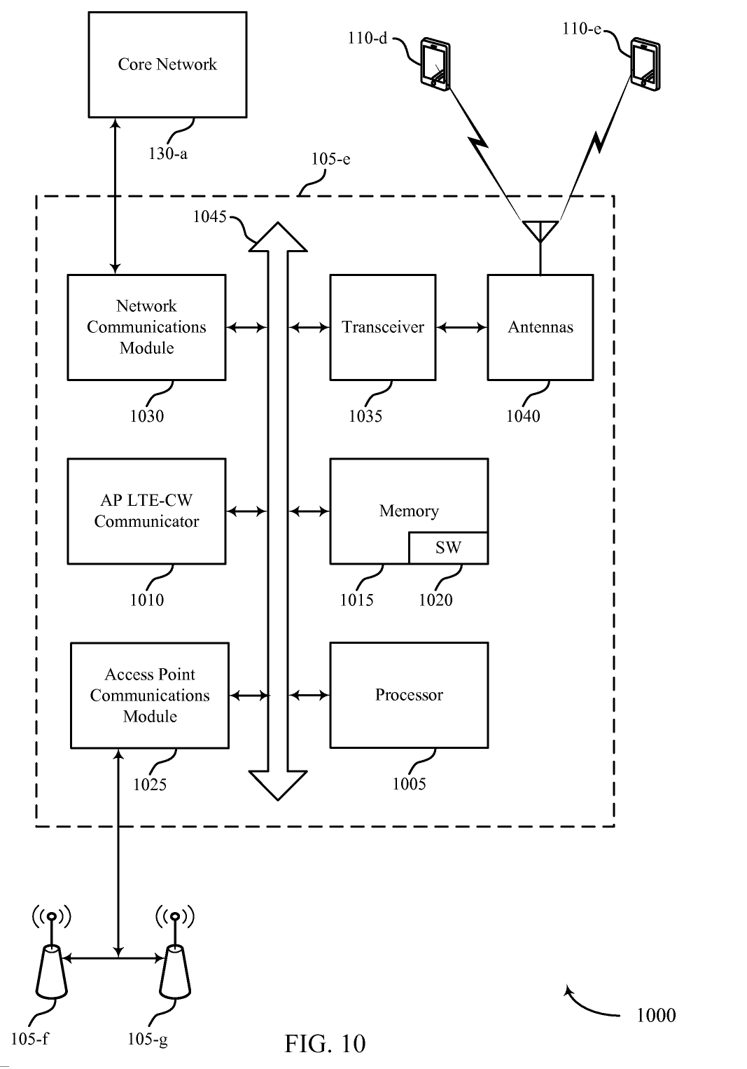

FIG. 10 shows a diagram of a system 1000 including an AP 105-e configured for channel estimation and packet decoding using an enhanced LTE-CW header in accordance with various aspects of the present disclosure. System 1000 may include AP 105-e, which may be an example of a wireless device 700, a wireless device 800, or an AP 105 described with reference to FIGS. 1, 2, and 7-9. AP 105-e may include an AP LTE-CW communicator 1010, which may be an example of an AP LTE-CW communicator 710 described with reference to FIGS. 7-13. AP 105-e may also include components for bi-directional voice and data communications including components for transmitting communications and components for receiving communications. For example, AP 105-e may communicate bi-directionally with STA 110-d or STA 110-e.

In some cases, AP 105-e may have one or more wired backhaul links. For example, AP 105-e may have a wired backhaul link to a core network. AP 105-e may also communicate with other STAs or APs, such as AP 105-f and AP 105-g via backhaul links. Each of the APs 105 may communicate with STAs using the same or different wireless communications technologies. In some cases, AP 105-e may communicate with other APs such as AP 105-f or AP 105-g utilizing AP communications module 1025. In some cases, AP 105-e may communicate with the core network through network communications module 1030.

The AP 105-e may include a processor 1005, memory 1015 (including software (SW)1420), transceiver 1035, and antenna(s) 1040, which each may be in communication, directly or indirectly, with one another (e.g., over bus system 1045). The transceiver 1035 may be configured to communicate bi-directionally, via the antenna(s) 1040, with STAs, such as STA 110-d and STA 110-e, which may be multi-mode devices. The transceiver 1035 (or other components of the AP 105-e) may also be configured to communicate bi-directionally, via the antennas 1040, with one or more other APs. The transceiver 1035 may include a modem configured to modulate the packets and provide the modulated packets to the antennas 1040 for transmission, and to demodulate packets received from the antennas 1040. The AP 105-e may include multiple transceivers 1035, each with one or more associated antennas 1040. The transceiver may be an example of a combined receiver 705 and transmitter 715 of FIG. 7.

The memory 1015 may include RAM and ROM. The memory 1015 may also store computer-readable, computer-executable software code 1020 containing instructions that are configured to, when executed, cause the processor 1005 to perform various functions described herein (e.g., channel estimation and packet decoding using an enhanced LTE-CW header, selecting coverage enhancement techniques, call processing, database management, message routing, etc.). Alternatively, the software 1020 may not be directly executable by the processor 1005 but be configured to cause the computer, e.g., when compiled and executed, to perform functions described herein. The processor 1005 may include an intelligent hardware device, e.g., a CPU, a microcontroller, an ASIC, etc. The processor 1005 may include various special purpose processors such as encoders, queue processing modules, base band processors, radio head controllers, digital signal processor (DSPs), and the like.

The AP communications module 1025 may manage communications with other APs. In some cases, a communications management module may include a controller or scheduler for controlling communications with STAs in cooperation with other APs. For example, the AP communications module 1025 may coordinate scheduling for transmissions to STAs for various interference mitigation techniques such as beamforming or joint transmission.

The components of wireless device 700, wireless device 800, and LTE-CW communicator 710 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

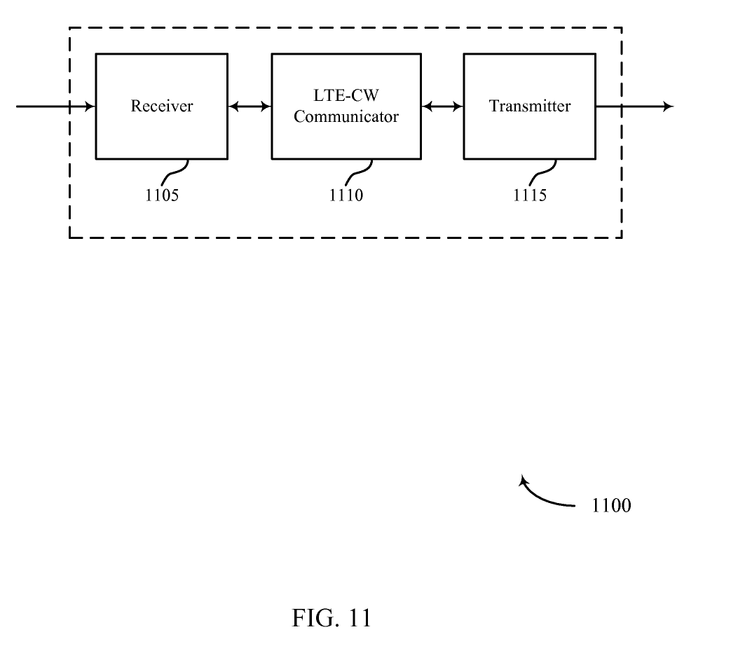

FIG. 11 shows a block diagram of a wireless device 1100 configured for channel estimation and packet decoding using an enhanced LTE-CW header in accordance with various aspects of the present disclosure. Wireless device 1100 may be an example of aspects of an AP 105 described with reference to FIGS. 1-6. Wireless device 1100 may include a receiver 1105, an LTE-CW communicator 1110, or a transmitter 1115. Wireless device 1100 may also include a processor. Each of these components may be in communication with each other.

The receiver 1105 may receive information such as packets, user data, or control information associated with various information channels (e.g., control channels, data channels, and information related to channel estimation and packet decoding using an enhanced LTE-CW header, etc.). Information may be passed on to the LTE-CW communicator 1110, and to other components of wireless device 1100. In some examples, the receiver 1105 may receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header.

The LTE-CW communicator 1110 may receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header, and descramble, in the time domain, the plurality of long training symbols according to a descrambling code associated with an AP.

The transmitter 1115 may transmit signals received from other components of wireless device 1100. In some examples, the transmitter 1115 may be collocated with the receiver 1105 in a transceiver module. The transmitter 1115 may include a single antenna, or it may include a plurality of antennas. In some examples, the transmitter 715 may transmit the channel estimate via a channel reporting mechanism to the AP.

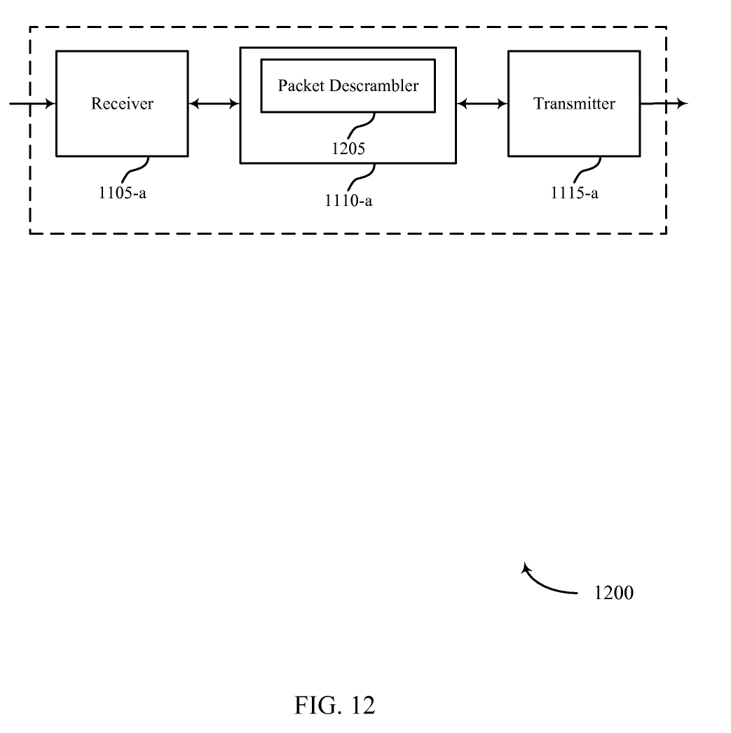

FIG. 12 shows a block diagram of a wireless device 1200 for channel estimation and packet decoding using an enhanced LTE-CW header in accordance with various aspects of the present disclosure. Wireless device 1200 may be an example of aspects of a wireless device 1100 or a STA 110 described with reference to FIGS. 1-7. Wireless device 1200 may include a receiver 1105-a, a LTE-CW communicator 1110-a, or a transmitter 1115-a. Wireless device 1200 may also include a processor. Each of these components may be in communication with each other. The LTE-CW communicator 1110-a may also include and a packet descrambler 1205.

The receiver 1105-a may receive information which may be passed on to LTE-CW communicator 1110-a, and to other components of wireless device 1200. The LTE-CW communicator 1110-a may perform the operations described with reference to FIG. 11. The transmitter 1115-a may transmit signals received from other components of wireless device 1200.

The packet descrambler 1205 may descramble, in the time domain, the plurality of long training symbols according to a descrambling code associated with an AP as described with reference to FIGS. 2-6. The packet descrambler 1205 may also identify a scrambled data region within the enhanced packet.

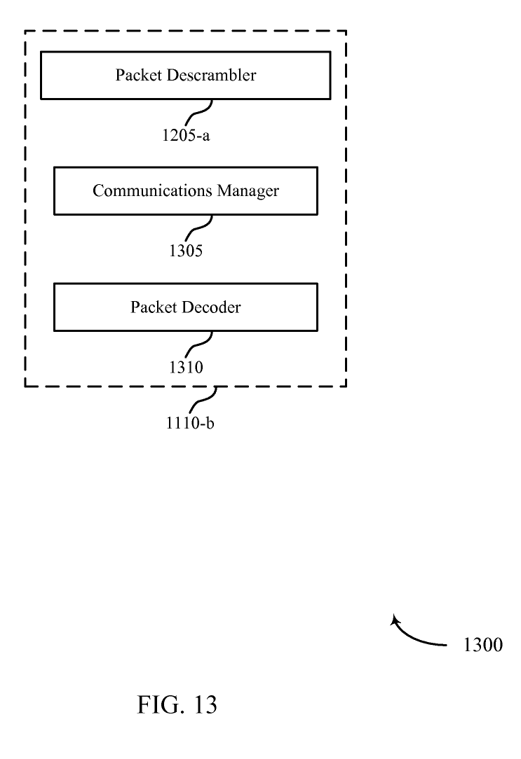

FIG. 13 shows a block diagram 1300 of a LTE-CW communicator 1110-b which may be a component of a wireless device 1100 or a wireless device 1200 for channel estimation and packet decoding using an enhanced LTE-CW header in accordance with various aspects of the present disclosure. The LTE-CW communicator 1110-b may be an example of aspects of a LTE-CW communicator 1110 described with reference to FIGS. 11-12. The LTE-CW communicator 1110-b may include a packet descrambler 1205-a, which modules may perform the functions described with reference to FIG. 12. The LTE-CW communicator 1110-b may also include a communications manager 1305.

The communications manager 1305 may also identify long training symbols associated with one or more neighboring APs. The communications manager 1305 may also determine a channel estimate for the channel based at least in part on the descrambled plurality of scrambled long training symbols. The communications manager 1305 may also estimate channel rotation based at least in part on the determined channel estimate and one or more narrow band tones embedded within a data region of the enhanced packet. In some cases, the communication manager 1305 may also determine a channel estimate for an interfering channel based at least in part on the descrambled plurality of scrambled long training symbols.

The packet decoder 1315 may identify a data region within the enhanced packet as described with reference to FIGS. 2-6. The packet decoder 1315 may also decode the data region based at least in part on the determined channel estimate. The packet decoder 1315 may also decode the scrambled data region based at least in part on the determined channel estimate and a second descrambling code associated with the AP. In some cases, the packet decoder 1315 may also perform interference rejection based at least in part on the determined channel estimate for the interfering channel. Performing interference rejection may include one or more of: minimum mean square error (MMSE) interference cancellation, successive interference cancellation (SIC), or any combination thereof.

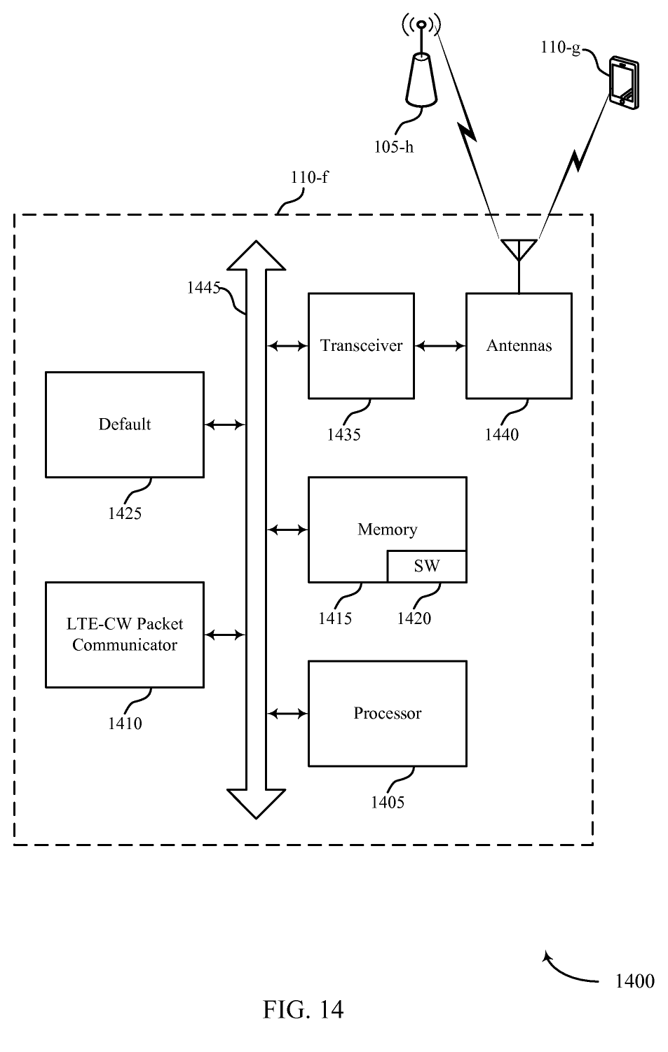

FIG. 14 shows a diagram of a system 1400 including a STA 110-f configured for channel estimation and packet decoding using an enhanced LTE-CW header in accordance with various aspects of the present disclosure. System 1400 may include STA 110-f, which may be an example of a wireless device 1100, a wireless device 1200, or a STA 110 described with reference to FIGS. 1, 2 and 11-13. STA 110-f may include a LTE-CW communicator 1410, which may be an example of a LTE-CW communicator 1110 described with reference to FIGS. 11-13. STA 110-f may also include components for bi-directional voice and data communications including components for transmitting communications and components for receiving communications. For example, STA 110-f may communicate bi-directionally with STA 110-g or AP 105-h.

STA 110-f may also include a processor 1405, and memory 1415 (including software (SW)) 1420, a transceiver 1435, and one or more antenna(s) 1440, each of which may communicate, directly or indirectly, with one another (e.g., via buses 1445). The transceiver 1435 may communicate bi-directionally, via the antenna(s) 1440 or wired or wireless links, with one or more networks, as described above. For example, the transceiver 1435 may communicate bi-directionally with a AP 105-h or another STA 110-g. The transceiver 1435 may include a modem to modulate the packets and provide the modulated packets to the antenna(s) 1440 for transmission, and to demodulate packets received from the antenna(s) 1440. While STA 110-f may include a single antenna 1440, STA 110-f may also have multiple antennas 1440 capable of concurrently transmitting or receiving multiple wireless transmissions.

The memory 1415 may include random access memory (RAM) and read only memory (ROM). The memory 1415 may store computer-readable, computer-executable software/firmware code 1420 including instructions that, when executed, cause the processor 1405 to perform various functions described herein (e.g., channel estimation and packet decoding using an enhanced LTE-CW header, etc.). Alternatively, the software/firmware code 1420 may not be directly executable by the processor 1405 but cause a computer (e.g., when compiled and executed) to perform functions described herein. The processor 1405 may include an intelligent hardware device, (e.g., a central processing unit (CPU), a microcontroller, an application specific integrated circuit (ASIC), etc.)

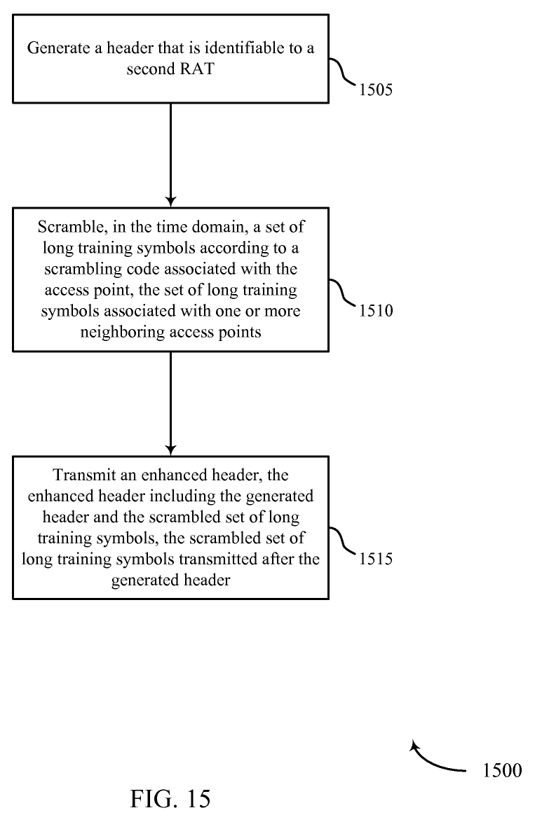

FIG. 15 shows a flowchart illustrating a method 1500 for channel estimation and packet decoding using an enhanced LTE-CW header in accordance with various aspects of the present disclosure. The operations of method 1500 may be implemented by an AP, such as an AP 105 or its components as described with reference to FIGS. 1-14. In some cases, the operations of method 1500 may be similarly performed by a STA, such as a STA 110 or its components as described with reference to FIGS. 1-14. For example, the operations of method 1500 may be performed by the AP LTE-CW communicator 710 as described with reference to FIGS. 7-14. In some examples, an AP may execute a set of codes to control the functional elements of the AP to perform the functions described below. Additionally or alternatively, the AP may perform aspects the functions described below using special-purpose hardware.

At block 1505, the AP may generate a header that is identifiable to a second RAT as described with reference to FIGS. 2-6. In certain examples, the operations of block 1505 may be performed by the header generator 805 as described with reference to FIG. 8.

At block 1510, the AP may scramble, in the time domain, a plurality of long training symbols according to a scrambling code associated with the AP, the plurality of long training symbols associated with one or more neighboring APs as described with reference to FIGS. 2-6. In certain examples, the operations of block 1510 may be performed by the packet scrambler 810 as described with reference to FIG. 8.

At block 1515, the AP may transmit an enhanced header, the enhanced header comprising the generated header and the scrambled plurality of long training symbols, the scrambled plurality of long training symbols transmitted after the generated header as described with reference to FIGS. 2-6. In certain examples, the operations of block 1515 may be performed by the transmitter 715 as described with reference to FIG. 7.

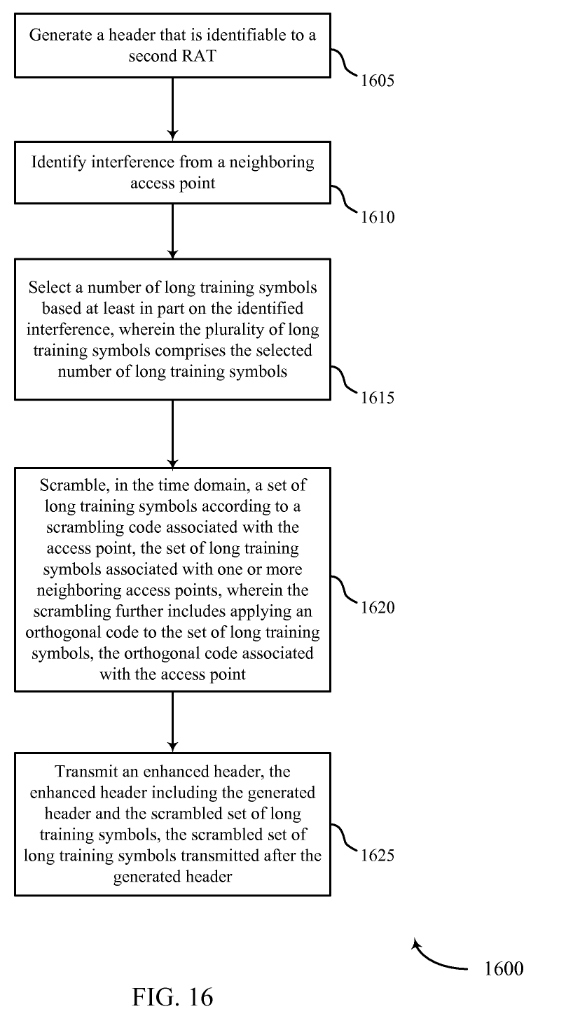

FIG. 16 shows a flowchart illustrating a method 1600 for channel estimation and packet decoding using an enhanced LTE-CW header in accordance with various aspects of the present disclosure. The operations of method 1600 may be implemented by an AP, such as an AP 105 or its components as described with reference to FIGS. 1-14. In some cases, the operations of method 1600 may be similarly performed by a STA, such as a STA 110 or its components as described with reference to FIGS. 1-14. For example, the operations of method 1600 may be performed by the AP LTE-CW communicator 710 as described with reference to FIGS. 7-14. In some examples, an AP may execute a set of codes to control the functional elements of the AP to perform the functions described below. Additionally or alternatively, the AP may perform aspects the functions described below using special-purpose hardware. The method 1600 may also incorporate aspects of method 1500 of FIG. 15.

At block 1605, the AP may generate a header that is identifiable to a second RAT as described with reference to FIGS. 2-6. In certain examples, the operations of block 1605 may be performed by the header generator 805 as described with reference to FIG. 8.

At block 1610, the AP may identify interference from a neighboring access point as described with reference to FIGS. 2-6. In certain examples, the operation of block 1610 may be performed by the packet scrambler 810 as described with reference to FIG. 8.

At block 1615, the AP may select a number of long training symbols based at least in part on the identified interference, wherein the plurality of long training symbols comprises the selected number of long training symbols as described with reference to FIGS. 2-6. In certain examples, the operation of block 1615 may be performed by the packet scrambler 810 as described with reference to FIG. 8.

At block 1620, the AP may scramble, in the time domain, a plurality of long training symbols according to a scrambling code associated with the AP, the plurality of long training symbols associated with one or more neighboring APs as described with reference to FIGS. 2-6. In some cases, the scrambling further comprises applying an orthogonal code to the plurality of long training symbols, the orthogonal code associated with the AP. In certain examples, the operations of block 1620 may be performed by the packet scrambler 810 as described with reference to FIG. 8.

At block 1625, the AP may transmit an enhanced header, the enhanced header comprising the generated header and the scrambled plurality of long training symbols, the scrambled plurality of long training symbols transmitted after the generated header as described with reference to FIGS. 2-6. In certain examples, the operations of block 1625 may be performed by the transmitter 715 as described with reference to FIG. 7.

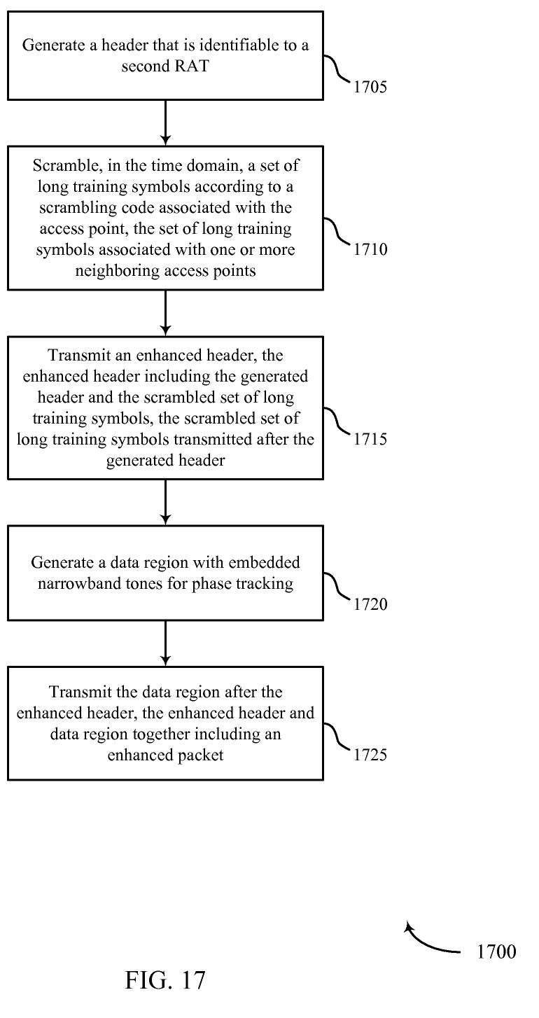

FIG. 17 shows a flowchart illustrating a method 1700 for channel estimation and packet decoding using an enhanced LTE-CW header in accordance with various aspects of the present disclosure. The operations of method 1700 may be implemented by an AP, such as an AP 105 or its components as described with reference to FIGS. 1-14. In some cases, the operations of method 1700 may be similarly performed by a STA, such as a STA 110 or its components as described with reference to FIGS. 1-14. For example, the operations of method 1700 may be performed by the AP LTE-CW communicator 710 as described with reference to FIGS. 7-14. In some examples, an AP may execute a set of codes to control the functional elements of the AP to perform the functions described below. Additionally or alternatively, the AP may perform aspects the functions described below using special-purpose hardware. The method 1700 may also incorporate aspects of methods 1500, and 1600 of FIGS. 15-16.

At block 1705, the AP may generate a header that is identifiable to a second RAT as described with reference to FIGS. 2-6. In certain examples, the operations of block 1705 may be performed by the header generator 805 as described with reference to FIG. 8.

At block 1710, the AP may scramble, in the time domain, a plurality of long training symbols according to a scrambling code associated with the AP, the plurality of long training symbols associated with one or more neighboring APs as described with reference to FIGS. 2-6. In certain examples, the operations of block 1710 may be performed by the packet scrambler 810 as described with reference to FIG. 8.

At block 1715, the AP may transmit an enhanced header, the enhanced header comprising the generated header and the scrambled plurality of long training symbols, the scrambled plurality of long training symbols transmitted after the generated header as described with reference to FIGS. 2-6. In certain examples, the operations of block 1715 may be performed by the transmitter 715 as described with reference to FIG. 7.

At block 1720, the AP may generate a data region with embedded narrowband tones for phase tracking as described with reference to FIGS. 2-6. In some cases, the data region is scrambled according to a second scrambling code associated with the AP. In certain examples, the operations of block 1720 may be performed by the data region generator 905 as described with reference to FIG. 9.

At block 1725, the AP may transmit the data region after the enhanced header, the enhanced header and data region together comprising an enhanced packet as described with reference to FIGS. 2-6. In certain examples, the operations of block 1725 may be performed by the transmitter 715 as described with reference to FIG. 7.

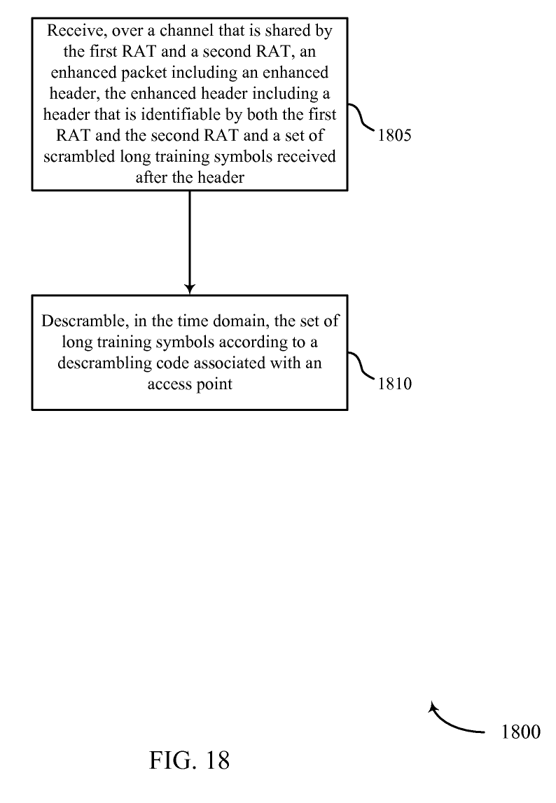

FIG. 18 shows a flowchart illustrating a method 1800 for channel estimation and packet decoding using an enhanced LTE-CW header in accordance with various aspects of the present disclosure. The operations of method 1800 may be implemented by a STA, such as a STA 110 or its components as described with reference to FIGS. 1-14. In some cases, the operations of method 1800 may be similarly performed by an AP, such as an AP 105 as described with reference to FIGS. 1-14. For example, the operations of method 1800 may be performed by the AP LTE-CW communicator 710 as described with reference to FIGS. 7-14. In some examples, an STA may execute a set of codes to control the functional elements of the STA to perform the functions described below. Additionally or alternatively, the STA may perform aspects the functions described below using special-purpose hardware. The method 1800 may also incorporate aspects of methods 1500, 1600, and 1700 of FIGS. 15-17.

At block 1805, the STA may receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header as described with reference to FIGS. 2-6. In certain examples, the operations of block 1805 may be performed by the receiver 1105 as described with reference to FIG. 11.

At block 1810, the STA may descramble, in the time domain, the plurality of long training symbols according to a descrambling code associated with an AP as described with reference to FIGS. 2-6. In certain examples, the operations of block 1810 may be performed by the packet descrambler 1205 as described with reference to FIG. 12.

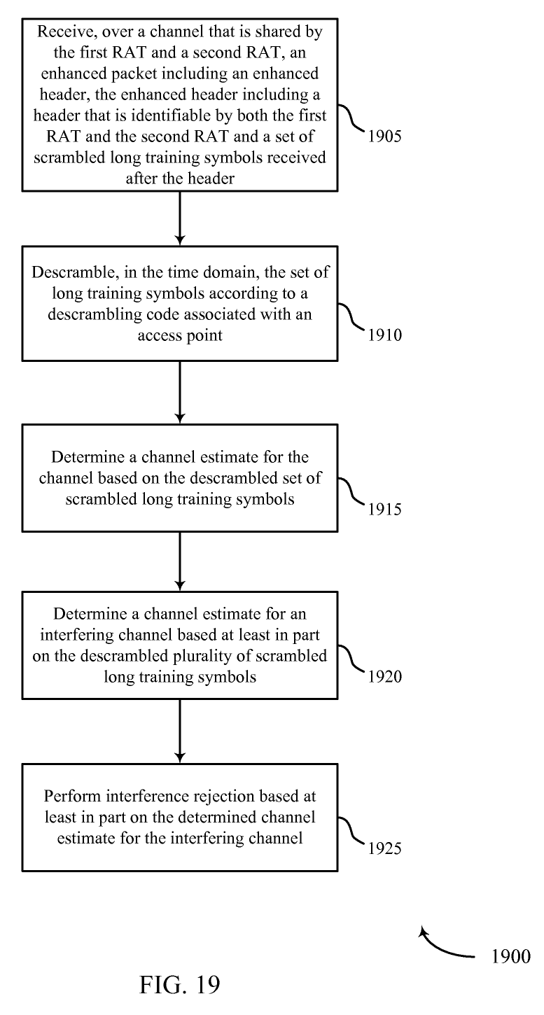

FIG. 19 shows a flowchart illustrating a method 1900 for channel estimation and packet decoding using an enhanced LTE-CW header in accordance with various aspects of the present disclosure. The operations of method 1900 may be implemented by a STA, such as a STA 110 or its components as described with reference to FIGS. 1-14. In some cases, the operations of method 1900 may be similarly performed by an AP, such as an AP 105 as described with reference to FIGS. 1-14. For example, the operations of method 1900 may be performed by the AP LTE-CW communicator 710 as described with reference to FIGS. 7-14. In some examples, an STA may execute a set of codes to control the functional elements of the STA to perform the functions described below. Additionally or alternatively, the STA may perform aspects the functions described below using special-purpose hardware. The method 1900 may also incorporate aspects of methods 1500, 1600, 1700, and 1800 of FIGS. 15-18.

At block 1905, the STA may receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header as described with reference to FIGS. 2-6. In certain examples, the operations of block 1905 may be performed by the receiver 1105 as described with reference to FIG. 11.

At block 1910, the STA may descramble, in the time domain, the plurality of long training symbols according to a descrambling code associated with an AP as described with reference to FIGS. 2-6. In certain examples, the operations of block 1910 may be performed by the packet descrambler 1205 as described with reference to FIG. 12.

At block 1915, the STA may determine a channel estimate for the channel based at least in part on the descrambled plurality of scrambled long training symbols as described with reference to FIGS. 2-6. In certain examples, the operations of block 1915 may be performed by the communications manager 1305 as described with reference to FIG. 13.

At block 1920, the STA may determine a channel estimate for an interfering channel based at least in part on the descrambled plurality of scrambled long training symbols as described with reference to FIGS. 2-6. In certain examples, the operations of block 1920 may be performed by the communications manager 1305 as described with reference to FIG. 13.

At block 1925, the STA may perform interference rejection based at least in part on the determined channel estimate for the interfering channel as described with reference to FIGS. 2-6. In certain examples, the operations of block 1925 may be performed by the packet decoder 1310 as described with reference to FIG. 13.

Thus, methods 1500, 1600, 1700, 1800, and 1900 may provide for channel estimation and packet decoding using an enhanced LTE-CW header. It should be noted that methods 1500, 1600, 1700, 1800, and 1900 describe possible implementation, and that the operations and the steps may be rearranged or otherwise modified such that other implementations are possible. In some examples, aspects from two or more of the methods 1500, 1600, 1700, 1800, and 1900 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication at an access point associated with a first radio access technology (RAT), comprising:
generating a header that is identifiable to a second RAT;
scrambling, in a time domain, a plurality of long training symbols according to a scrambling code associated with the access point, the plurality of long training symbols associated with one or more neighboring access points; and
transmitting an enhanced header, the enhanced header comprising the generated header and the scrambled plurality of long training symbols, the scrambled plurality of long training symbols transmitted after the generated header.

2. The method of claim 1, further comprising:
identifying interference from a neighboring access point;
selecting a number of long training symbols based at least in part on the identified interference, wherein the plurality of long training symbols comprises the selected number of long training symbols.

3. The method of claim 1, wherein the scrambling further comprises applying an orthogonal code to the plurality of long training symbols, the orthogonal code associated with the access point.

4. The method of claim 3, wherein the orthogonal code is a Walsh code.

5. The method of claim 4, wherein the plurality of long training symbols comprises a first long training symbol and a second long training symbol, and wherein the Walsh code is [1,−1]; and
the method further comprising applying a first index ‘1’ to the first long training symbol and a second index ‘-1’ to the second long training symbol.

6. The method of claim 1, further comprising:
generating a data region with embedded narrowband tones for phase tracking; and
transmitting the data region after the enhanced header, the enhanced header and the data region together comprising an enhanced packet.

7. The method of claim 6, wherein the data region is scrambled according to a second scrambling code associated with the access point.

8. The method of claim 6, further comprising:
transmitting the enhanced packet over a channel that is shared by the first RAT and the second RAT.

9. The method of claim 1, further comprising:
communicating control information over a subband of a licensed radio frequency spectrum band, the licensed radio frequency spectrum band comprising a narrow frequency channel.

10. The method of claim 9, wherein the control information comprises at least one of scheduling information for uplink transmissions, downlink transmissions, or a combination thereof, or an indication of the scrambling code associated with the access point.

11. The method of claim 1, further comprising:
identifying a station is configured for license assisted wireless fidelity (Wi-Fi); and
scrambling, in the time domain, the plurality of long training symbols based at least in part on the identifying.

12. The method of claim 1, further comprising:
scrambling, in a frequency domain, the plurality of long training symbols based at least in part on a random sequence.

13. The method of claim 12, wherein the random sequence is a pseudo-random (PN) sequence.

14. A method of wireless communication at a station that is associated with a first radio access technology (RAT), comprising:
receiving, over a channel that is shared by the first RAT and a second RAT, an enhanced packet comprising an enhanced header, the enhanced header comprising a header that is identifiable by both the first RAT and the second RAT and a plurality of scrambled long training symbols received after the header; and
descrambling, in a time domain, the plurality of scrambled long training symbols according to a descrambling code associated with an access point.

15. The method of claim 14, further comprising:
identifying the descrambling code associated with the access point to descramble the plurality of scrambled long training symbols.

16. The method of claim 14, further comprising:
identifying long training symbols associated with one or more neighboring access points.

17. The method of claim 14, further comprising:
determining a channel estimate for the channel based at least in part on the descrambled plurality of scrambled long training symbols.

18. The method of claim 17, further comprising:
identifying a data region within the enhanced packet; and
decoding the data region based at least in part on the determined channel estimate.

19. The method of claim 17, further comprising:
identifying a scrambled data region within the enhanced packet; and
decoding the scrambled data region based at least in part on the determined channel estimate and a second descrambling code associated with the access point.

20. The method of claim 17, further comprising:
transmitting the channel estimate to the access point.

21. The method of claim 17, further comprising:
estimating channel rotation based at least in part on the determined channel estimate and one or more narrow band tones embedded within a data region of the enhanced packet.

22. The method of claim 14, further comprising:
determining a channel estimate for an interfering channel based at least in part on the descrambled plurality of scrambled long training symbols.

23. The method of claim 22, further comprising:
performing interference rejection based at least in part on the determined channel estimate for the interfering channel.

24. The method of claim 23, wherein performing interference rejection comprises one or more of: minimum mean square error (MMSE) interference cancellation, successive interference cancellation (SIC), or any combination thereof.

25. An apparatus for wireless communication associated with a first radio access technology (RAT), comprising:
a processor;
memory in electronic communication with the processor; and
instructions stored in the memory and operable, when executed by the processor, to cause the apparatus to:
generate a header that is identifiable to a second RAT;
scramble, in a time domain, a plurality of long training symbols according to a scrambling code associated with the apparatus, the plurality of long training symbols associated with one or more neighboring access points; and
transmit an enhanced header, the enhanced header comprising the generated header and the scrambled plurality of long training symbols, the scrambled plurality of long training symbols transmitted after the generated header.

26. The apparatus of claim 25, wherein the instructions are operable to cause the processor to:
apply an orthogonal code to the plurality of long training symbols, the orthogonal code associated with the apparatus.

27. The apparatus of claim 25, wherein the instructions are operable to cause the processor to:
generate a data region with embedded narrowband tones for phase tracking; and
transmit the data region after the enhanced header, the enhanced header and the data region together comprising an enhanced packet.

28. An apparatus for wireless communication that is associated with a first radio access technology (RAT), comprising:
a processor;
memory in electronic communication with the processor; and
instructions stored in the memory and operable, when executed by the processor, to cause the apparatus to:
receive, over a channel that is shared by the first RAT and a second RAT, an enhanced packet comprising an enhanced header, the enhanced header comprising a header that is identifiable by both the first RAT and the second RAT and a plurality of scrambled long training symbols received after the header; and
descramble, in a time domain, the plurality of scrambled long training symbols according to a descrambling code associated with an access point.

29. The apparatus of claim 28, wherein the instructions are operable to cause the processor to:
identify the descrambling code associated with the access point to descramble the plurality of scrambled long training symbols.

30. The apparatus of claim 28, wherein the instructions are operable to cause the processor to:
determine a channel estimate for the channel based at least in part on the descrambled plurality of scrambled long training symbols.
